(19) United States
(12) Patent Application Publication
(10) Pub. No.: US 2014/0199970 A1
(43) Pub. Date: Jul. 17, 2014

(54) METHODS AND SYSTEMS RELATING TO PRIVACY IN LOCATION BASED MOBILE APPLICATIONS

(71) Applicant: Christopher Klotz, Ottawa (CA)

(72) Inventor: Christopher Klotz, Ottawa (CA)

(21) Appl. No.: 14/089,162

(22) Filed: Nov. 25, 2013

Related U.S. Application Data
(60) Provisional application No. 61/752,645, filed on Jan. 15, 2013.
(60) Provisional application No. 61/836,227, filed on Jun. 18, 2013.

(51) Int. Cl. H04W 12/02; H04W 4/02

(52) U.S. Cl. CPC H04W 12/02; H04W 4/02
USPC 455/411

(57) ABSTRACT

Many consumer electronic devices today provide highly accurate geo-location information on the user of the electronic device. In many instances users are enticed by the benefits of the geo-location aspects of the service(s) or application(s) being offered to them without considering the drawbacks in terms of privacy etc. Accordingly, it would be beneficial to provide users of social network (social media) applications as well as other software applications, software systems, electronic devices etc. with options to adjust the level of privacy they have from the geo-location perspective much like they expect privacy in other aspects of their daily life, both electronic and otherwise.

### CROSS-REFERENCE TO RELATED APPLICATIONS

This patent application claims the benefit of U.S. Provisional Patent Application 61/752,645 filed Jan. 15, 2013 entitled “Methods and Systems Relating to Privacy in Location Based Services” and U.S. Provisional Patent Application 61/836,227 filed Jun. 18, 2013 entitled “Methods and Systems Relating to Privacy in Location Based Mobile Applications”, the entire contents of these patent applications being included by reference.

### FIELD OF THE INVENTION

This invention relates to geo-location applications and more specifically to providing mobile application users with selectable privacy settings for geo-location within said applications.

### BACKGROUND OF THE INVENTION

The Technology, Media and Telecommunications (TMT) business has grown within the past decade through the widespread deployment of wireless devices, personal computers, Internet, and broadband networks which today represent a value chain of over $3 trillion worldwide, including content providers, advertisers, telecommunications companies and electronics suppliers (White Paper Wireless Social Networking from iSuppli, July 2008). Amongst the multiple market segments today for this value chain are applications that are relatively new, rapidly evolving and yet considered to be central and essential to the continued evolution of this value chain. One such segment is so-called “social networking” which focuses on online communities of people who share interests and/or activities, or who are interested in exploring the interests and activities of others (see for example Wikipedia http://en.wikipedia.org/wiki/Social_networking). Social networks are evolving and impacting many activities of users including their family, friends, dating, businesses, Government, medical, and education.

In the next decade wireless social networking products, applications, components, and advertising are anticipated to generate more than $2.5 trillion in revenue by 2020, according to iSuppli (Press Release, Jun. 4, 2008 http://www.isuppli.com/NewsDetail.aspx?ID=12930). Today the demographic penetration of social networking is significantly skewed towards the 18-29 year old range, see Table 1 below, a sector of the population traditionally considered having limited financial resources in respect of hardware, products, components and service plans (see for example Pew's Research Centre for the People and The Press “Internet's Broader Role in Campaign 2008”, Kohut et al, January 2008, http://people-press.org/report/384/internets-broader-role-in-campaign-2008).

TABLE 1
Social Media Usage Demographics

| | Total | 18-29 | 30-39 | 40-100 |
|---|---|---|---|---|
| Using Social | 22 | 67 | 21 | 6 |
| Media | | | | |

Expanding these statistics to “absolute” numbers in conjunction with data for teenagers (see for example Pew's Research Centre for the People and The Press “Teens, Privacy and Online Social Networks”, Lenhert and Maddern, April 2007, http://www.pewinternet.org/Reports/2007/Teens-Privacy-and-Online-Social-Networks.aspx) then we obtain an overall snapshot of social networking, as shown in Table 2 below, wherein nearly 75% of social networking users are under 30 years of age. During the next decade it is anticipated that mobile devices, such as cellular telephones, smart phones, personal digital assistants (PDA), portable media players, gaming consoles, etc will become the primary channel for either viewing content from, providing content to, or generally accessing the Internet (World Wide Web) for consumers and that social networking will have moved predominantly into the wireless realm providing the degree and type of ubiquitous always available connection that consumers demand. At the same time it is anticipated that this evolution with be accompanied in parallel by both the creation of a new generation of applications that will greatly expand the appeal and utility of social networking, and expansions/evolutions in the functionality of the very wireless devices themselves. In many segments of the social networking industry enterprises will finally generate profits.

TABLE 2
Overall Demographics of Social Networking Use in Social Networks

| | | Percentage of US | Approximate US |
|---|---|---|---|
| Age | Estimated Number of | Population in Age | Population in Age |
| Range | Social Network Users | Range | Range |
| 12-14 | 5,565,000 | 45% | 12,350,000 |
| 15-17 | 8,335,000 | 65% | 13,000,000 |
| 18-29 | 34,250,000 | 67% | 51,100,000 |
| 30-39 | 8,600,000 | 21% | 41,950,000 |
| 40-100 | 8,250,000 | 6% | 137,250,000 |
| TOTAL | 65,0000 | 25% | 255,650,000 |

Accordingly, as users move to such wireless devices as their primary means of communicating, accessing content, and using applications in the next decade, the technological innovations will also have to appear within the semiconductor and display industries globally. So if we consider a typical hypothetical social networking user of today then we find that they have both a personal computer (PC) and a smart phone, and that whilst their smart phone has a browser and they should be able to access most online sources that they can access from their PC, particularly those with wireless application protocol (WAP). However they do not use their smart phone as a computer, they use their PCs at work/home for anything that is a task requiring more than a couple of minutes or accessing visually intensive data. On the other hand they use their smart phone for short online tasks when on the move, limiting access time due to the subscriber plan they have with their service provider, such as Verizon™, AT&T™, T-Mobile™, BT™ etc. They will extend their access time if they are able to find a free wireless hotspot.

The hypothetical users computer social networking activities are based around writing emails, accessing social network sites such as Facebook™ Hi5™, LinkedIn™, Flickr™, Classmates™, Last™, MySpace™, Twitter™, Windows Live Spaces™, etc., where they read and comment on friends blogs, and upload pictures. A lot of these social networking sites are essentially passive, reading content, clicking here and there. Some social networking websites are more active, where they create and upload content, which will be read and seen by someone else. These social networking applications are however primarily text based and low in audio-visual content. These users also use other application such as Google Talk™, Windows Live Messenger™ and Skype™ for chatting. Their approach to instant messaging (IM) is usually simple: keeping IM turned on (with status online/busy) all the time they are at the computer and have long, informal conversations with whoever is online (one or more people). They will also access other applications such as YouTube™ or dating websites such as LavaLife™, Yahoo Personals™ etc.

Hence, we find that this hypothetical user has mobile phone social networking activities that are very different from those above on the PC. They currently do not translate all their use from their PC to their mobile phone, mainly because the situations they are currently in and because their smart phone has a small screen not suitable for the majority of tasks they perform at the computer. As a result the hypothetical user obviously makes telephone calls, sends texts, and some electronic mail (email) but these emails will be generally shorter than their PC counterparts, and will typically be replies rather than initiating emails or so-called push emails. They download Rich Site Summaries (RSS) with news, use Twitter™ (which limits postings to 140 characters), chat on Yahoo™ Messenger, Blackberry™ Messenger etc. and in a limited percentage send direct messages with PIN-to-PIN messaging.

Another characteristic of mobile phone social networking with subscribers, and to a lesser extent computer social networking, is the trend of users rapidly shifting social networking applications and an overall lack of retention from initial use. Even applications such as Facebook™ that work across both computer and mobile environments only achieve a 50% retention rate (Nielsen NetRatings Press Release May 2006, http://www.nielsen-online.com/pr/pr_{—}060511. pdf). Social networking applications such as Twitter™ which are currently causing substantial comments and being discussed as the new Facebook™, YouTube™ etc. are only achieving retention rates of 40% (defined in users returning the following month from registering). Accordingly, many Social Networking Applications (SOCNETAPs) and other service applications, marketing push based applications etc. are seeking to address this by making their application(s) more ubiquitous to the user's daily life such that aspects such as dashboards, advertising, special offers, etc. are dynamically based upon the user's location. However, having such geo-location based services raises to many users issues over privacy as their physical location at any point can be tracked, monitored, analysed. Likewise, information posted by them within SOCNETAPs may include embedded geo-location data which they do not wish to have publicly accessible.

With tens of millions of SOCNETAP users in the United States who are now growing up with portable high performance electronic devices as true consumable elements of their life and evolution from local to remote cloud based storage the information set on an individual is increasing substantially as to their purchasing habits, likes, dislikes, associations, thoughts etc. but hitherto their physical whereabouts was more difficult. Today Government's mandate Global Positioning System chips are within every cellphone for emergency services whilst other service providers and devices exploit geo-location for multiple services to users ranging from driving directions, to offering them alternative restaurants within their location providing a particular cuisine without requiring the user to enter their location, to offering dating services, etc. In many instances users are enticed by the benefits of the geo-location aspects of the service(s) or application(s) without considering the drawbacks in terms of privacy etc.

Accordingly, it would be beneficial to provide users of SOCNETAPs as well as other software applications, software systems, electronic devices with options to adjust the level of privacy they have from the geo-location perspective much like they expect privacy in other aspects of their daily life, both electronic and otherwise.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to address drawbacks in the prior art relating to geo-location applications and more specifically to privacy within mobile applications for users.

In accordance with an embodiment of the invention there is provided a method comprising:
receiving from a user upon an electronic device associated with the user an indication of a degree of privacy;
receiving upon the electronic device location information relating to the location of the electronic device; and
modifying the location information in dependence upon at least the indication of the degree of privacy.

In accordance with an embodiment of the invention there is provided a method comprising:
storing within a memory of an electronic device associated with the user an indication of a degree of privacy;
receiving upon the electronic device electronic content including location information relating to the electronic content; and
modifying the location information within the electronic content in dependence upon at least the indication of the degree of privacy.

In accordance with an embodiment of the invention there is provided a method comprising:
receiving from a user upon an electronic device associated with the user an indication of a degree of privacy;
acquiring with the electronic device digital content, the digital content including location information data relating to the location of the electronic device; and
modifying the digital content in dependence upon at least the indication of the degree of privacy.

In accordance with an embodiment of the invention there is provided a method comprising:
receiving at a server from an electronic device associated with a user first digital content, the first digital content having associated with it metadata including location information data relating to the location of the electronic device when the first digital content was acquired;
receiving at the server second digital content, the second digital content having associated with it metadata including location information data relating to another location established by the user;
receiving at the server a request from a third party to view posted digital content relating to the user, the request including at least data relating to an identity of the third party; and
providing to the third party content as the posted digital content comprising one of the first digital content and the second digital content, the one of being determined in dependence upon at least the data relating to an identity of the third party.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts an exemplary profile creation for a SOCNETAP according to an embodiment of the invention;

FIG. 2 depicts an exemplary information and revenue flow for a user accessing a SOCNETAP according to an embodiment of the invention at another premium level of service;

FIGS. 3A and 3B depict an exemplary expansion of information and associated revenue flow for a user accessing a SOCNETAP according to an embodiment of the invention at a premium level of service;

FIG. 4 depicts an exemplary expansion of information presenting profiles based upon location information relative to a user for the user accessing a SOCNETAP according to an embodiment of the invention at a premium level of service;

FIG. 5 depicts an exemplary screen for a user accessing a SOCNETAP according to an embodiment of the invention at a premium level of service wherein the user is presented with matches against their multiple profiles and options to contact them;

FIG. 6 depicts an exemplary expansion of information presenting matching users geographically relative to a user for the user accessing a SOCNETAP according to an embodiment of the invention at a premium level of service;

FIG. 7A depicts user location maps for a user accessing a user accessing a SOCNETAP according to an embodiment of the invention at a premium level of service;

FIG. 7B depicts low and high zoom location maps for a user accessing a SOCNETAP according to an embodiment of the invention at a premium level of service;

FIG. 8 depicts user interfaces providing privacy control features according to embodiments of the invention;

FIG. 9 depicts an exemplary flowchart for a user exploiting privacy control settings according to an embodiment of the invention;

FIG. 10 depicts a graph of location offset arising from rounding GPS coordinate data at two different latitudes;

FIG. 11 depicts accurate and approximate user location maps for a user accessing a SOCNETAP according to an embodiment of the invention;

FIG. 12 depicts accurate and approximate user location maps for a user accessing a SOCNETAP according to an embodiment of the invention;

FIG. 13 depicts a geo-location privacy policy being applied automatically to activities of a user according to an embodiment of the invention;

FIG. 14 depicts a geo-location privacy policy being applied automatically to activities of a user according to an embodiment of the invention in conjunction with a third party application;

FIG. 15 depicts a geo-location privacy policy setting screen displayed to a user within a Privacy Module according to an embodiment of the invention;

FIG. 16 depicts a geo-location privacy policy setting screen displayed to a user within a Privacy Module according to an embodiment of the invention;

FIG. 17A to 17C depict geo-location based privacy policy screens displayed to a user within a Privacy Module according to an embodiment of the invention wherein the user selects a location to present to other users based upon geo-tagged content within a third party application;

FIG. 18 depicts geo-location based privacy policy screens displayed to a user within a Privacy Module according to an embodiment of the invention wherein the user selects digital content to employ in association with a SOCNETAP to present to other users based upon content within a third party application;

FIG. 19 depicts a geo-location based privacy policy screens displayed to a user within a Privacy Module according to an embodiment of the invention wherein the user selects a location to present to other users based upon preferences, current location, and current speed;

FIG. 20 depicts an embodiment of the invention wherein content presented to user of a SOCNETAP varies according to their relationship with the user in order to support their approximate/offset location presented to the other user;

FIG. 21 depicts an embodiment of the invention wherein a user within another software application is provided with location based options in dependence upon their selection of true or false locations

FIG. 22 depicts an embodiment of the invention wherein a user selects a new location based upon cluster analysis;

FIG. 23 depicts an embodiment of the invention wherein a user selects a new location based upon the location of other contacts; and

FIG. 24 depicts an embodiment of the invention wherein a user's location is modified but location specific information is accessible.

### DETAILED DESCRIPTION

The present invention is directed to geo-location applications and more specifically to providing mobile application users with selectable privacy settings for geo-location within said applications.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader. A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

An “application” as used herein may refer to, but is not limited to, a software application installed upon a PED/FED or accessed by a user upon their PED/FED from a remote service provider and/or software provider which exploits positioning information established in dependence upon the, for example, user's PED/FED internal global positioning system (GPS), network node identity, and/or network node triangulation. This positioning information being used by a software system and/or software application to provide one or more services to either the user, such as, for example, advising them of local services, special offers, travel issues, etc., or to other users such as, for example, a dating service providing geo-location information, a social media application providing geo-location information, and emergency services such as police, ambulance, and fire. Within the descriptions below the embodiments of the invention are primarily described from the perspective of a dating web service providing users with selectable options relating to providing their geo-location information. However, it would evident to one skilled in the art that the use of these exemplary software applications and/or software systems does not represent any implied, implicit, or explicit limitation in the application of the embodiments of the invention.

A “software system and/or software application” (SSSA) as used herein may refer to, but is not limited to, either a software system or a software application exploiting methodologies of embodiments of the invention as described herein relating to geo-location based services as part of an overall service provided to users and the associated user privacy policies and user privacy controls. This includes devices, but is not limited to, such services as social networks, social media, information provisioning services, and fleet management applications.

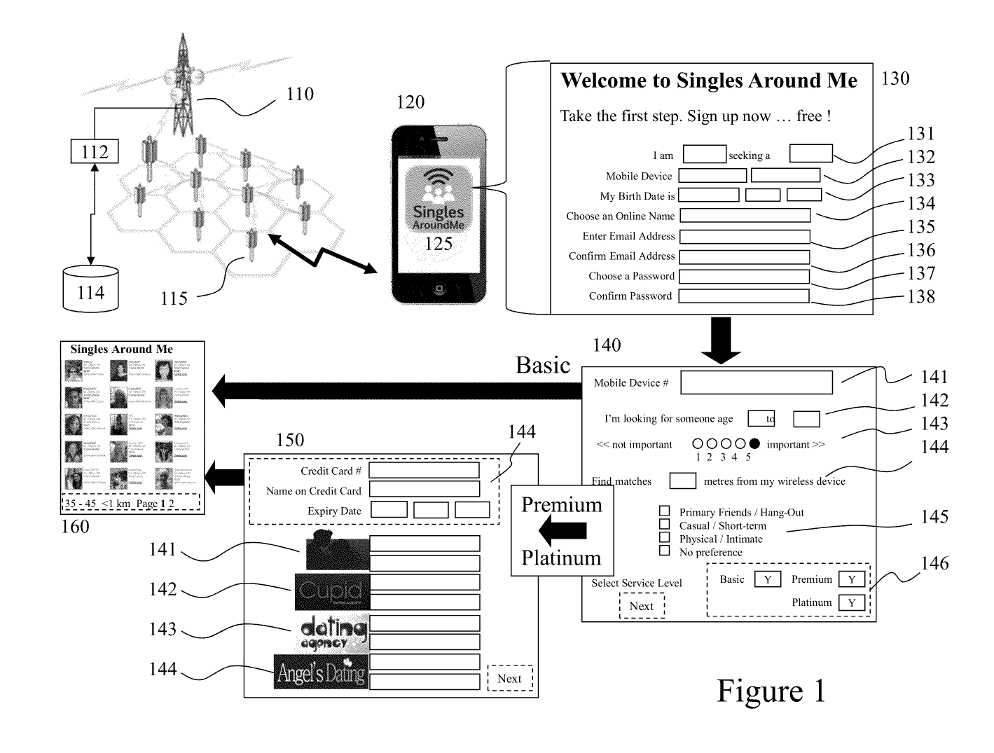

A Social Networking Application (SOCNETAP) or Social Networking Applications (SOCNETAPs) as used herein may refer to, but is not limited to, either a SSSA which provides a social networking service an online service, platform, or Internet portal that focuses on facilitating the building of social networks or social relations among users who, for example, currently or wish to share interests, activities, backgrounds, or real-life personal connections. A social network service typically consists of a representation of each user (often a profile), their social links to other individuals, and a variety of additional services. Most social network services are web-based and provide means for users to interact over the Internet, such as e-mail and instant messaging. Online community services may be considered as a social network service, though in a broader sense, social network service usually means an individual-centred service whereas online community services are group-centred. Whilst embodiments of a user's use of a SOCNETAP within FIGS. 1 through 6 are presented with respect to dating and/or matchmaking type applications it would be evident that embodiments of the invention may be employed with respect to any SOCNETAP allowing users to display and/or exploit location data relating to other users and themselves either in real time or periodically updated. Examples of SOCNETAPs include, but are not limited to, Facebook™, LinkedIn™, Twitter™, Google+, Google Latitude, Qzone, Habo, Bebo, Loopt, NearbyFeed Sonar, WhosHere, and Tagged.

Referring to FIG. 1 there is depicted an exemplary profile creation sequence for a SOCNETAP according to an embodiment of the invention. The user, not shown for clarity, possesses a wireless device 120 and has remotely downloaded a new SOCNETAP SINGLES AROUND ME™ (SAM) from the server 114 of SINGLES AROUND ME Inc. which is connected to the wireless device 120 via telecom network 112 to a base station 110 and a femtocell 115. Having downloaded SINGLES AROUND ME™ an icon 125 is displayed upon the wireless device 120. Upon selecting icon 125 the first time the application enters at first screen 130 for the user to generate a profile. As such the user is asked to define in this example if they are a man/woman seeking a man/woman in entry field 131, the manufacturer and model number of the mobile device that they will be accessing SAM with in line 132, their date of birth in line 133, to select an online name in line 134, enter an email address in line 135, verify that email address in line 136, choose a password in line 137, and verify that password in line 138.

Having completed first screen 130 the user is then presented with second screen 140 wherein they enter their mobile device number 141, an age range 142 of the individual they are seeking, an indication 143 of how important matching characteristics are that they define, a distance 144 to find matches within a distance away from their wireless device, select relationship 145 which determines the type of relationship they are seeking, and service level 146 which is available as “Basic”, “Premium” and “Platinum”. If the user has selected the basic service then the SAM application (SAM) proceeds to display search result screen 160 to the user by presenting images and information relating to individuals matching the users search characteristics.

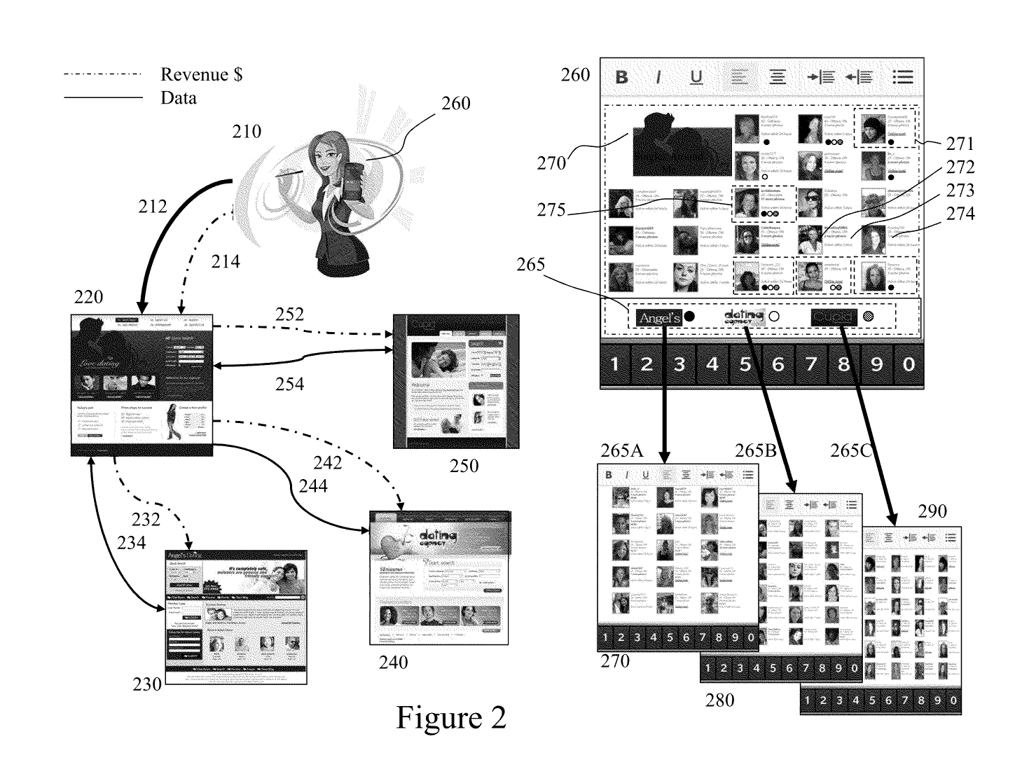

If the user has selected a “Premium” or “Platinum” service level then SAM moves to a third entry screen 150 wherein they are required to enter payment information 145 for the account, shown as a credit card number, the name on the credit card and it's expiry date. The user is also able at this point to enter any other profiles that they have on Sami first profile fields 141, and is also able at this point to enter any profiles that they have created on partner SOCNETAPs to SINGLES AROUND ME™. In this example the user is presented with first partner SOCNETAP “Cupid” 142, second partner SOCNETAP “Dating Agency” 143 and third partner “Angel's Dating” 144. Upon completion of third screen 150 the user is presented with search result screen 160. As will become evident in respect of the embodiments described below in respect to FIGS. 2 through 12 the user registered with SAM and having “Premium” or “Platinum” services may exploit the partnerships of SAM to widen the pool of potential contacts and/or manage their multiple profiles through Sample's access other features such as privacy controls which may be not offered or more limited in the “Basic” membership.

Referring to FIG. 2 there is depicted an exemplary information and revenue flow for a user accessing a SOCNETAP according to an embodiment of the invention at a second premium level of service, such as for example “Platinum” on the SOCNETAP Sambas described supra in respect of FIG. 1. As shown user 210 is using a PED 260 upon which they are accessing SAM 220 via a telecommunications network, not shown for clarity. The user 210 provides information to SAM 220 and retrieves information from SAM 220 relating to activities which include for example searching for other users matching their search criteria, managing their account, messaging users they have established contact with etc. These being exemplified by first dataflow 212, the provisioning of these services having been provided by their selection of a “Platinum” service level and payment of their subscriber payment 214 to SAM 220.

Within FIG. 2 the first dataflow 212 results in display screen 270 being displayed upon PED 260 which presents profiles to the user 210 matching their search criteria. Display screen 270 displays profiles that relate to registered users not only from SAM 220 itself but also from its partner SOCNETAPs. These partner SOCNETAPs being shown on display screen 270 in window 265 and being “Angel's” 230, “Dating Agency” 240 and “Cupid” 250. The information provided by the user 210 to SAM 220 in first dataflow 212 is parsed by SAM 220 into second dataflow 234 which is provided to “Angel's” 230, third dataflow 244 to “Dating Agency” 240, and fourth dataflow 254 to “Cupid” 250. Each of these partner SOCNETAPs returning profile data relating to users of these partner SOCNETAPs that matches the search criteria of user 210.

The display screen therefore shows profiles which may be only registered with SINGLES AROUND ME, for example “Winnie-2” 271, registered with one partner SOCNETAP such as “Lisa3756” 272 with “Angel's 230, “Snoopy-2000” 273 with “Dating Agency” 240, and “Sweet265” 274 with “Cupid” 250 for example, or with multiple partner SOCNETAPs such as “FreeAtLast” 275 for example. Selection of one of these profiles associated with a user profile on a partner SOCNETAP results in a revenue flow from SAM 220 to the partner SOCNETAPs, “Angel's” 230, “Dating Agency” 240 and “Cupid” 250, as shown by first through third revenue flows 232, 242, and 252 respectively. For example “Angel's” 230 would receive revenue via first revenue flow 232 for selection of “Lisa3756” 272, “Dating Agency” 240 would receive revenue via second revenue flow 242 for selection of “Snoopy-2000” 273, and “Cupid” 250 would receive revenue via third revenue flow 252 for selection of “Sweet265” 274. Selection of “Winnie-2” 271 does not trigger revenue flow to any of the partner SOCNETAPs as they are only registered with SAM 220.

In addition to the retrieved search results presented in display screen 270, which combines the results from SAM 220 and the partner SOCNETAPs, user 210 is able to search each of the partner SOCNETAPs discreetly. For example, selecting the icon for “Angel's” 230 within the window 265 then via first flow 265A the user 210 is presented with second display screen 270 which is only users registered with “Angel's” 230. Selecting the icon for “Dating Agency” 240 in window 265 triggers flow second flow 265B wherein the user is presented with third display screen 280 with only users registered with “Dating Agency” 240, and similarly selecting the icon for “Cupid” 250 in window 265 triggers flow second flow 265C wherein the user is presented with third display screen 290 with only users registered with “Cupid” 250.

Accordingly the user 210 by selecting the “Platinum” service on SOCNETAP SAM 220 is able to search and retrieve profiles for users on the partner SOCNETAPs, “Angel's” 230, “Dating Agency” 240 and “Cupid” 250, in addition to those on SAM 220. These searches may be specific to one SOCNETAP or may merge results from them all. In this manner the user 210 has a significantly expanded base of potential matches to search and select from.

It would be evident to one skilled in the art that the revenue flows in FIG. 2 supra from the SAM 220 to “Angel's” 230, “Dating Agency” 240 and “Cupid” 250 were triggered by a the user retrieving detailed profiles from the partner SOCNETAP websites. It would be evident that where a user such as “FreeAtLast” 275 is present on multiple SOCNETAPs that some revenue sharing may be applied to the multiple SOCNETAPs that “FreeAtLast” 275 is registered with or that the user 210 may select one of the three SOCNETAPs to have the detailed profile retrieved from. Optionally, the revenue may be determined for example if the profile is retrieved from a search of all partner SOCNETAPs as well as SAM 220 or a specific search of one partner SOCNETAP. It would also be evident that the revenue may be triggered based upon other events other than retrieving a detailed profile, such as the initiation of communication between the user 220 and the member associated with the selected profile, or be based upon the method of communication between the two users, for example a simple “Hi” in an automated message might not trigger a revenue flow but a user generated message may not. Alternatively, whilst the revenue flows have been shown as originating with SAM 220 they may alternatively be in the opposite direction. For example, a user on “Cupid” 250 sees that the user 210 has browsed and retrieved their profile but not contacted them, this user on “Cupid”250 looks at the user 210 profile on SAM 220 and decides to contact them. In this scenario, the arrangement between SAM 220 and the partner SOCNETAPs might provide for the revenue flow to be from “Cupid” 250 to SAM 220.

It would be apparent to one skilled in the art that the revenue flows discussed supra in respect of FIG. 2 may be ones that are established upon a scale that varies according to predetermined factors that may include for example the degree of information retrieved, the method of contact, the extent of communications, whether one or other user opens an otherwise private area of information (such as additional photographs, text, etc.), etc. Optionally the user 210 having established themselves at a “Platinum” service level, rather than “Basic” or “Premium”, has access to additional services or features which are not offered to those at these other services levels. For example, it was discussed supra that a member profile might have public and private areas, the latter of which would not be accessible to the user unless the member allowed. Such a concept might be expanded to that where there is a first summary public profile, a second detailed public profile, and a private profile. As such the user with a “Platinum” service level would have access to the first and second public profiles unlike those at “Basic” and “Premium”.

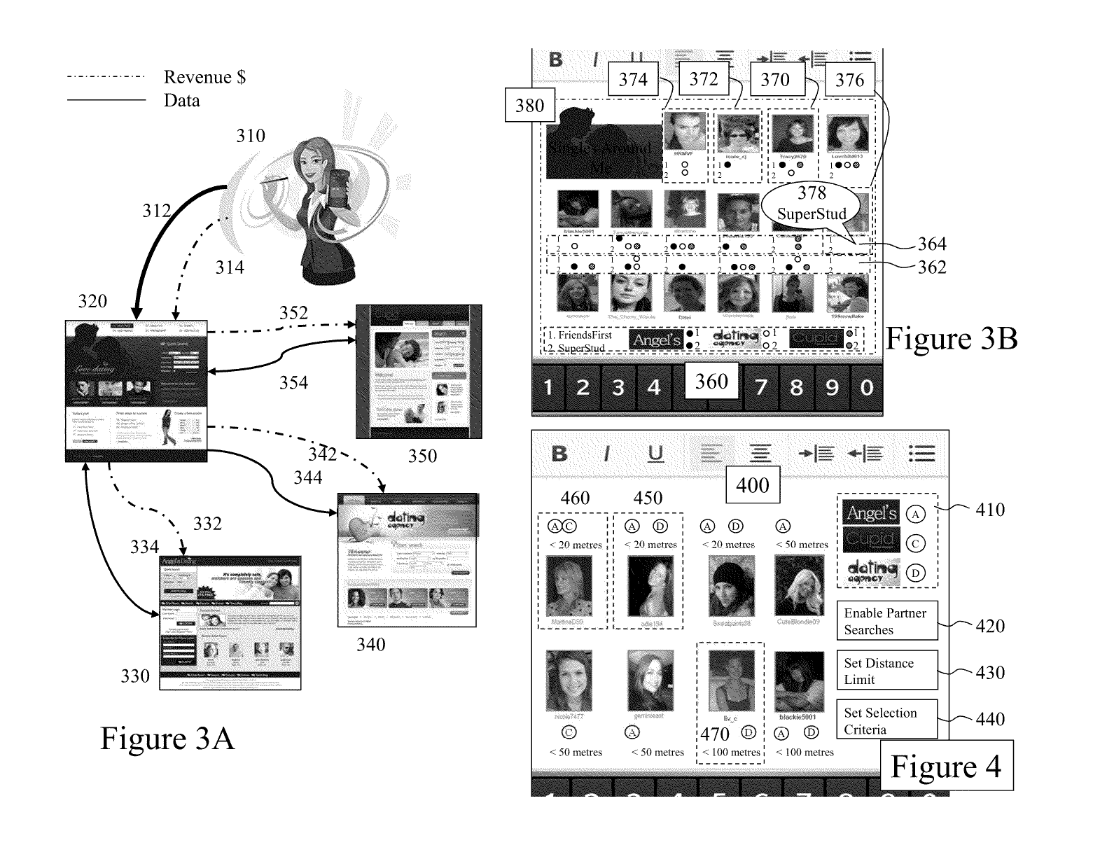

In respect of additional services or features available to those with increased service level as discussed supra FIG. 3 depicts an exemplary expansion of the information and associated revenue flow for a user wherein the user is not only retrieving brokered profiles from SAM and its partner SOCNETAPs but this information is presented with respect to multiple profiles associated with the user. Accordingly, in FIG. 3 a user 310 is shown employing a mobile device 360 upon which they are accessing SAM320 via a telecommunications network, not shown for clarity. The user 310 provides information to SAM320 and retrieves information from SAM320 relating to activities which include for example searching for other users matching their search criteria, managing their account, messaging users they have established contact with etc. These being exemplified by first dataflow 312, the provisioning of these services having been provided by their selection of a “Platinum” service level for example and payment of their subscriber payment 314 to SAM320. SAM320 in performing the required service to user 310 parses the search information contained within the first dataflow 312 and provides this to the partner SOCNETAPs, via second dataflow 334 to “Angel's” 330, third dataflow 344 to “Dating Agency” 340, and fourth dataflow 354 to “Cupid” 350.

The resulting second to fourth dataflows 334, 344, and 354 providing information to SAM320 allowing it to display a display screen 380 to user 310. At the bottom of display 380 is information bar 362 that presents the partner SOCNETAPs, “Angel's” 330, “Dating Agency” 340, and “Cupid” 350 together with marker identifiers (not identified explicitly) which are labeled numerically to match two profiles of the user 310 on SAM320, namely “FriendsFirst” and “SuperStud”. The display screen 380 thereby presents profiles to the user 310 with information relating to the partner SOCNETAP and the user profile. Accordingly, “Cupid Calling” 370 is shown having a profile on each of “Angel's” 330, “Dating Agency” 340, and “Cupid” 350 that matches “FriendsFirst”, “Nikitita” 372 is shown having a profile on “Angel's” 330 that matches “FriendsFirst”, “BlueIsland” 374 is shown having a profile only on “Dating Agency” 340 that matches both “FriendsFirst” and “SuperStud”, whilst “JustLooking” 376 is shown to have no matching profiles on any of “Angel's” 330, “Dating Agency” 340, and “Cupid” 350. If the user 310 selected “JustLooking” 376 then an icon 378 pops up identifying “JustLooking” 376 as matching their “SuperStud” profile.

The user 310 when registering with SAM320 was able to identify multiple profiles that they had on both SAM320 and the partners SOCNETAPs “Angel's” 330, “Dating Agency” 340, and “Cupid” 350. Accordingly the user 310 might be able to select from this list of multiple profiles which ones they wished to have displayed on display screen 380 when performing their searches.

It would be evident to one skilled in the art that the exemplary embodiment described supra in respect of FIG. 3 considers the results presented to user 310 on display screen 380 based upon three partner SOCNETAPs, namely “Angel's” 330, “Dating Agency” 340, and “Cupid” 350. However, due to the marketing or socio-demographic factors it might be that user 310 experiences or knows that for example “Dating Agency” 340 is typically associated with profiles of, for example, mature men and women seeking longer term relationships, than, for example, a younger age group on “Angel's” 330 who are more interested in seeking short term encounters. Accordingly it would be evident that the user 310 may within SAM320 be able to establish a preference for searching particular partner SOCNETAPs when using their “FriendsFirst” profile to their “SuperStud” profile. Optionally, user 310 may wish to not receive profiles of other members on these partner SOCNETAPs who have multiple profiles, or who do have multiple profiles but exclude those matching one or more specific profiles, for example receive those who match “FriendsFirst” on the partner SOCNETAPs but exclude those who also have a match to “SuperStud”.

It would also be apparent to one skilled in the art that in the exemplary embodiments presented supra in respect of FIGS. 1 through 3 that users with multiple profiles have been presented wherein they have a common user profile name. This is possible with some SOCNETAPs today, such as LavaLife™, which allow a user to have the same profile name in different categories of their SOCNETAP, for example, “friends”, “relationship” and “intimate”, whilst others do not separate to the same degree and allow users to select multiple categories for one profile name, for example Adult Friend Finder™ Other SOCNETAPs do not permit a member to have a single profile with multiple categories but do allow a user to have multiple profiles, each one associated with a different category. Naturally, it is difficult for a user to know that these multiple profiles are associated with the same individual if they present different user names within a single SOCNETAP or multiple SOCNETAPs and different profiles, including images etc. Accordingly, a benefit to a user of a brokered SOCNETAP, such as SINGLES AROUND ME™, is the ability to identify such members when using the brokered SOCNETAP at a higher level, for example “Platinum” upon Sambas discussed supra.

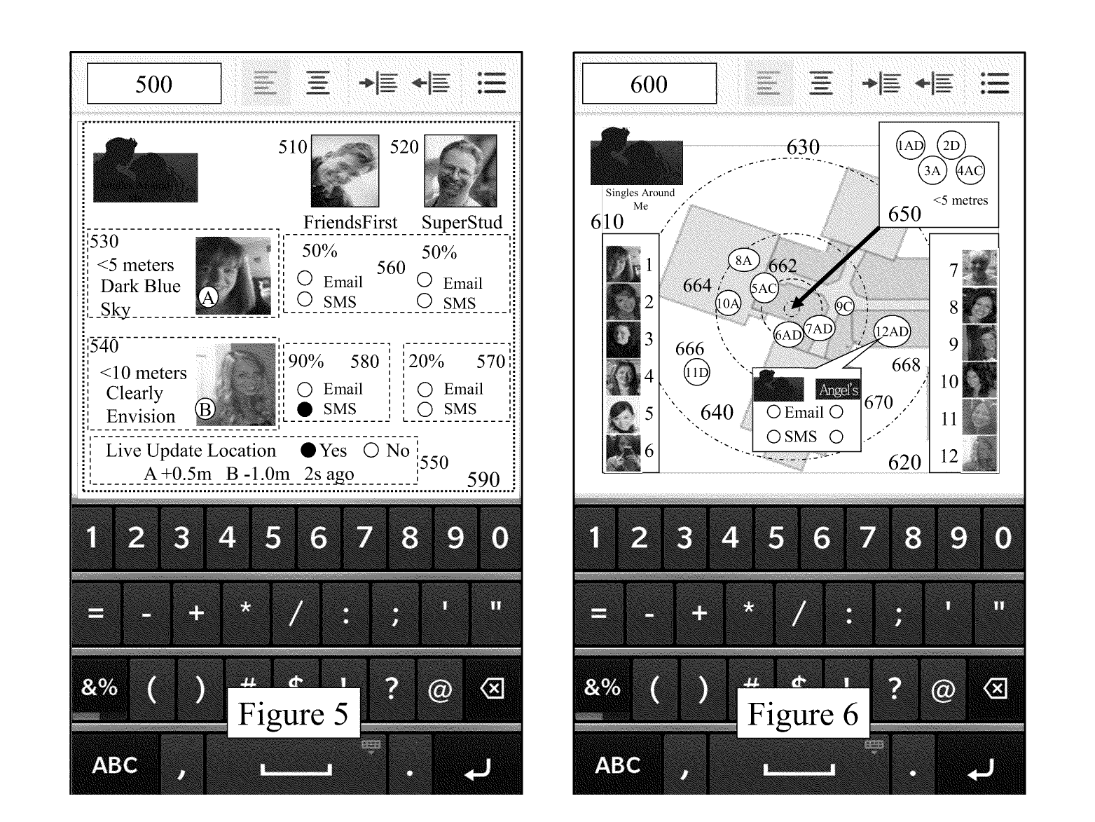

Now referring to FIG. 4 there is depicted a mobile device 400 upon which are shown the results of a profile search using SINGLES AROUND ME™. As shown there is partner box 410 which lists the partner SOCNETAPs whose results are presented, these being “Angel's”, “Cupid”, and “Dating Agency” with identifiers “A”, “C”, and “D”. A fourth partner SOCNETAP, who would have been denoted by “B” is not shown as the user has de-selected them within a different screen for example. As described supra a user may elect to not include a particular SOCNETAP as their experience is that registered members of that SOCNETAP do not match their particular search criteria, or for some other reason. Also shown on mobile device 400 is partner box 420 that allows the user to move to the other screen described supra allowing them to enable or disable searching of specific partner SOCNETAPs. Distance box 430 allows the user to set a distance limit for their searching, for example 100 meters, 2 kilometers, 25 kilometers etc. The distance limit for example may be set low when the user associated with the mobile device 400, not shown for clarity, is for example within a downtown environment on a Friday evening seeking a partner for dinner.

The distance limit for example may be set high when the user associated with the mobile device 400 is at home on a Sunday evening or at work during the week and seeking to browse a wide contact base. Also shown is selector box 440 that links the user to another screen wherein the user may adjust selection criteria including for example which of their user profiles to use or a threshold for matching other profiles against their search criteria. Accordingly the results of the user search are shown upon the mobile device 400 including “Donna-2” 450 who is shown as being within 5 meters of the user and has profiles on “Angel's” and “Dating Agency”. Also shown is “Dark Blue Sky” 460 who is registered with “Angel's” and “Cupid” and is less than 20 meters away and “Moonlight” 470 who is registered with “Dating Agency” and is less than 100 meters away.

It would be apparent to one skilled in the art that the distance determination of the users, such as “Donna-2” 450, “Dark Blue Sky” 460, and “Moonlight” 470, within SAM is unlike that of prior art applications wherein the determination of distances for members relative to the user searching are based upon the entry of information relating to their residence, work or other fixed location, this entry predominantly a postcode (zip code) associated with the user. It would also be apparent to one skilled in the art that the distance determination relative to the user may be established with one of many different approaches, the particular subset of approaches being dependent upon the distance range. For example, at distances of several kilometers to tens of kilometers it might be sufficient to determine which cell tower a mobile device associated with each user is within. At a distance of a kilometer or so determination within coverage of a cell tower may be employed using triangulation, power or timing for example. Distances of meters may for example be determined by triangulation from multiple femtocells within an urban environment. Alternatively, wherein the mobile device is equipped with a Global Positioning System (GPS) interface then the location of the user may be established by interrogating the mobile device and retrieving its location. Normal GPS accuracy being approximately 20 meters.

It would also be apparent to one skilled in the art that updating the distance indications to the user of the mobile device 400 may be performed on time bases that are established either by preset parameters within the SOCNETAP or established by the user of the mobile device 400. For example preset parameters may include increasing the frequency of updating as determined separation decreases or increasing the frequency at particular times of day, such as for example between 1 pm and 2 pm representing lunchtime and between 5 pm and 11 pm representing the major time when users may be dining out in restaurants, being in nightclubs, at home browsing, etc. Beneficially, adjusting the frequency of location updates based upon such presets reduces the requirements of the user's mobile device to transmit its location to SINGLES AROUND ME over the wireless network, which if performed at high frequency represents a significant overall data usage per month for the user within a mobile device plan with a carrier that has high penalties for exceeding a preset limit or is expensive to give unlimited usage.

Optionally, the SAM application may establish the frequency with which updating of location information is undertaken dynamically based upon actions of the user, for example the user may be shown updates of profiles every 5 minutes but if they request a real-time update of a particular user is requested to pay an additional fee and the target members mobile device is set to transmit position every 10 seconds for example, a portion of the additional fee may potentially go direct to the target members account to offset their increased mobile data usage.

Now referring to FIG. 5, there is a display screen 590 for a user, not shown for clarity, accessing a SOCNETAP according to an embodiment of the invention, such as SAM for example at a premium level of service wherein the user is presented with matches against their multiple profiles and options to contact them. Accordingly, display screen 590 upon a mobile device 500 shows two user profiles associated with the user of the mobile device 500, these being “FriendsFirst” 510 and “SuperStud” 520 as well as two member profiles that the user has selected which represent people the user is interested in meeting immediately having determined that they are within close proximity to them. These being “Dark Blue Eyes” 530 and “Clearly Envision” 540, where for each in addition to a profile image and their profile name there is an indication of distance from the user, namely less than 5 meters and less than 10 meters respectively. Also shown on the display 590 against “Dark Blue Eyes” 530 is first match matrix 560 wherein there is displayed a percentage match of the member profile of “Dark Blue Eyes” 530 against the profiles of “FriendsFirst” 510 and “SuperStud” 520 which are shown at 50% in each instance. Also for each of “FriendsFirst” 510 and “SuperStud” 520 there are icons representing “Email” and “SMS” (Short Message Service) which allow the user to contact “Dark Blue Eyes” 530 with either of these methods with a message indicating that they are either “FriendsFirst” 510 and “SuperStud” 520.

Similarly, “Clearly Envision” 540 has second match matrix 580 and third match matrix 590 associated with themselves and the user profiles of “FriendsFirst” 510 and “SuperStud” 520. Again each of the second match matrix 580 and third match matrix 570 contain the icons representing “Email” and “SMS” together with the matching percentage of the respective profiles which are 90% and 20% respectively in this case for “FriendsFirst” 510 and “SuperStud” 520. Also displayed is an option 550 for the user to enable or disable a live update of location, which is shown as enabled and presents the information text “A +0.5 m B −1.0 m 2 s ago”. This telling the user that “Dark Blue Eyes” 530 had moved further away by 0.5 m, “Clearly Envision” had moved closer by 1.0 m and the last position update was 2 seconds ago. Accordingly, our user is aware that “Clearly Envision” 530 who has a very high match percentage to their “FriendsFirst” 510 profile is very close and getting closer and has selected “SMS” to contact them. In a subsequent screen or pop-up within the current display screen 560 the user would then be able to enter a quick text message to “Clearly Envision” 530 that would be sent to their mobile device via SAM indicating that “FriendsFirst” 510 was nearby and wished to meet them.

It would be evident to one skilled in the art that the user registered with a brokering SOCNETAP not only has increased information available to them in respect of the number of members, that members have multiple profiles but also in respect of having this increased information presented to them in a manner that is user friendly and where necessary is updated in real time, such as location information. Referring to FIG. 6 there is depicted an exemplary expansion of information presenting matching users geographically relative to a user for the user accessing a SOCNETAP according to an embodiment of the invention, such as SINGLES AROUND ME™, at a premium level of service. As such a user, not shown for clarity, has selected the SOCNETAP application SAM upon their mobile device 600 and performed a profile search. However, the user has selected an alternate display option and is presented with local geographic information 640 upon which are presented the search results. Examples of sources for such geographic information 640 being for example Yahoo™, Google™, and Bing™, and may be schematic or satellite derived. As such the user is presented with first profile bar 610 which displays profile images for users returned in the search results, these being numbered 1-6, and second profile bar 620 which similarly displays profile images and are numbered 7-12.

Superimposed onto the geographical information 640 are distance radii 630 which for example are set at 5 meters, 20 meters, 50 meters, and 100 meters. Display box 650 shows that members 1, 2, 3, 4 are within 5 meters and also that they have profiles upon multiple partner SOCNETAPs, indicated for example by “1AD” and “4AC”. Other members for example “8” 662, “10” 664, “11” 666 and “12” 668 are also displayed upon the geographic information 640. The user in this case has selected member “12” 668 either by this icon on the map or their image within second profile bar 620 resulting in pop-up 670 appearing that shows that member “12” is registered with SINGLES AROUND ME™, the “A” within their icon, and “Angel's”, the “D” within their icon. Pop-up 670 providing the option for the user to contact this member by either “Email” or “SMS” via either their SAM or “Angel's” profiles.

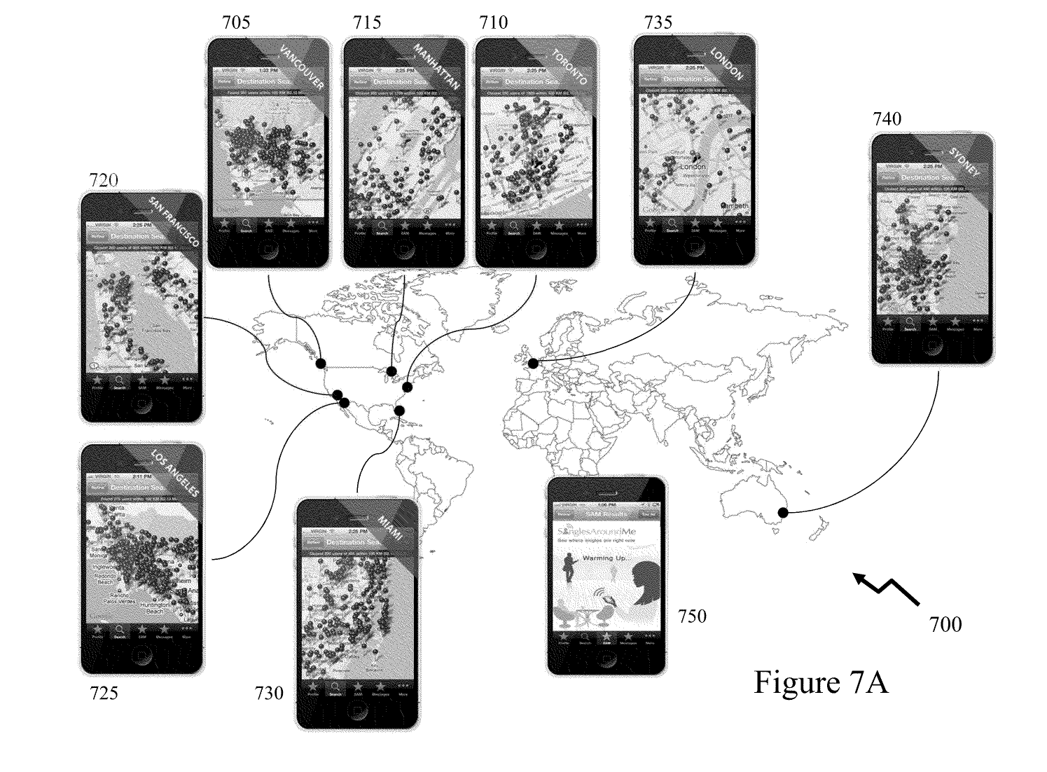

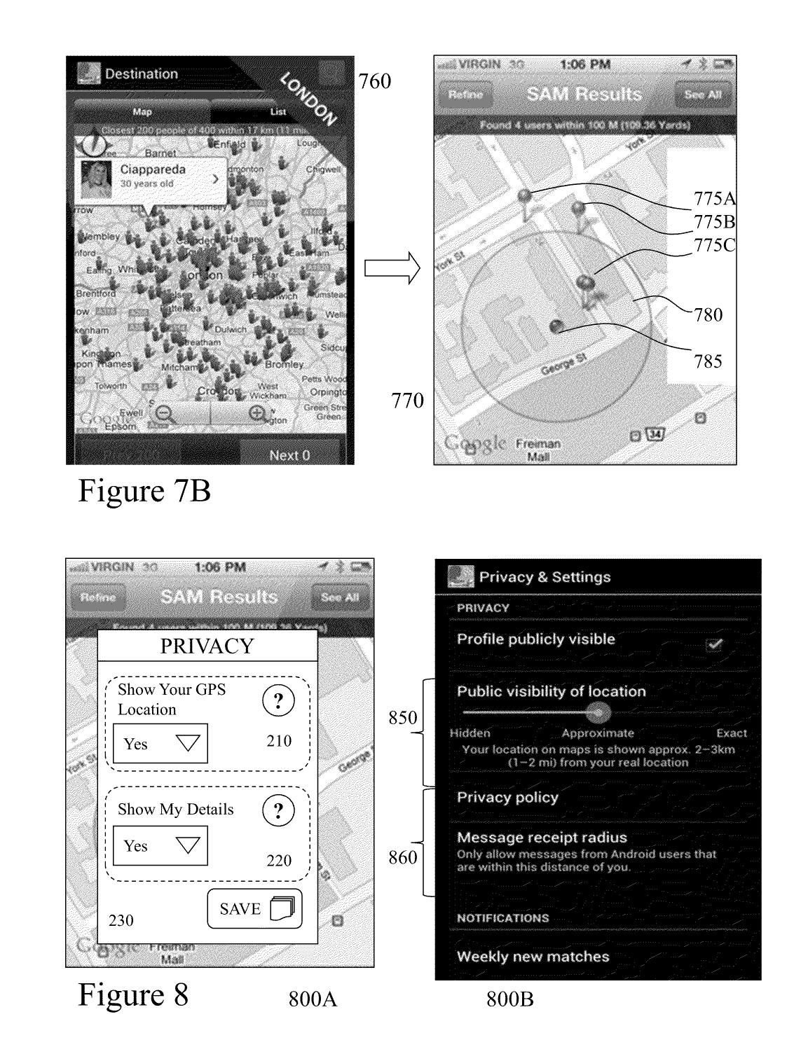

It would be apparent that the presentation of the location information within a geographical context allows the user to contact a member with a more specific message that would be possible using the prior art SOCNETAPs where location information is derived from static points, i.e. a postcode or zip code. For example referring to FIG. 4 above the user can message the member saying that they would like to meet them at a coffee shop within the Food Court at the Mall they are both currently within. Alternatively, the user in another scenario, not presented visually, would see that whilst the user they wish to meet is say only 20 meters away, that between them there is a river running through the downtown core they are currently within and that there are no bridges either way for several hundred meters. Hence, they can adjust their message to this information increasing potentially the impression they make on the other member. Further, as evident from FIGS. 7A, 7B, 8, 11, and 12 below rather than being presented with lists of other users the user may be provided with a map of the area around themselves or another selected location, e.g. a holiday destination, work destination, etc. onto which are marked locations of users matching their search criteria. Such indications may, for example, be stick pins which when the user touches or brings their finger near to for a predetermined period of time highlight data on a pop-up screen including, for example, name, age, and a profile image.

However, it would be evident that whilst location based features of SOCNETAPs such as described supra in respect of identifying other members of a SOCNETAP based upon location may provide users with benefits that these also present issues to these very same users as whilst, for example, they would like to filter others users based upon location they do not want their location released either at all or without the same degree of accuracy as they are looking at others. For example, many women find the concept of other users being able to accurately exploit location tracking of themselves an issue of personal security. In other situations a user may feel comfortable providing location data to some other users but not all. Referring to FIG. 7A there is a map 700 of the world wherein the user of a SOCNETAP has entered first to eighth cities resulting in first to eighth city maps 705 through 740 being presented to the user on their PED 750 via the SOCNETAP. First to eight city maps 705 through 740 representing Vancouver, Toronto, Manhattan, San Francisco, Los Angeles, Miami, London, and Sydney respectively. If the user is not within these cities at the time they perform a search within the SOCNETAP, e.g. SINGLES AROUND ME™, as they are considering a trip to one of these locations then the mapping of users onto the city map does not have to be as precise or accurate, necessarily, as when the user is in the city and seeking to actively meet another user of the same SOCNETAP. However, today geo-location systems exploiting GPS use the full GPS field as accuracy is usually considered as being an over-riding priority for the SSSA. Accordingly, as depicted in FIG. 7B a user in London may toggle from a first city map 760 to a Surrounding Map 770 which depicts their immediate vicinity together with the locations of other users within it, first to third users 775A through 775C respectively, together with their Current Location 785 and a Radius 780, e.g. 50 meters, given that surround map 770 depicts a 100 meter by 100 meter region around the user.

However, in the example above for first to eighth city maps 705 through 740 in FIG. 7A and first city map 760 in FIG. 7B each user's current location does not need to be mapped accurately to the map due to the scale, e.g. first city map 760 covers approximately 17 km×17 km such that an accuracy of 5 m has little meaning. Accordingly, the user GPS data may be taken by the SSSA, and in other instances the SOCNETAP itself, and rounded to a predetermined number of digits in respect of the user's current position or their position the last time their location was updated. Accordingly, a reduction in data may be obtained which in instances where the geo-location data is provided to the SOCNETAP user's PED and/or communicated via wireless links etc. beneficial to reduce transmission size, reduce latency, and improve the user's experience with accuracy commensurate with the mapping currently being performed by the user. Accordingly, as the user switches to Surrounding Map 770, such as within the SOCNETAP “Singles Around Me” to search locally to their current location then the accuracy may be increased such that the first to third users 775A through 775C respectively are locationally established accurately together with the users Current Location 785.

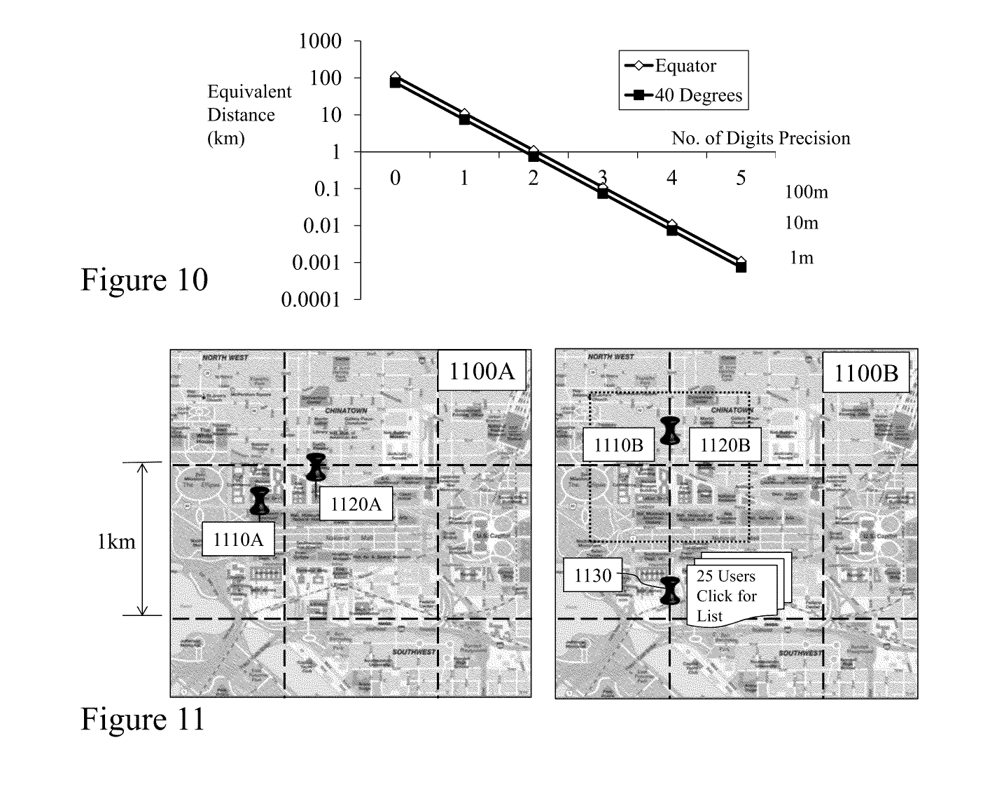

As depicted in FIG. 10, and described below, rounding a GPS coordinate, e.g. 37.81997, −122.47859 using the World Geodetic System (1984) (N37 49.19819 W122 28.71539 in Decimal Minutes or N 37° 49′ 11.8914″, W 122° 28′ 42.9234″ in Degrees Minutes Seconds) representing Golden Gate Bridge in San Francisco results in the location being offset by approximately a 1 m to several kilometers as the GPS coordinate is rounded from 5 decimal places of a degree, e.g. 37.81997, −122.47859, to 1 decimal place, e.g. 37.8 −122.5. The exact offset being dependent upon how far the GPS coordinate is rounded, such that for example −37.84999 when rounded to 37.8 is a larger offset than −37.80001. Accordingly, when displaying users in large area maps such as those depicted in first to eighth city maps 705 through 740 of FIG. 7A, an accuracy of several hundred meters might typically suffice allowing location data to be truncated to 3, probably 2, decimal places when transmitting and presenting. Then when within a small area map, such as Surrounding Map 770 in FIG. 7B, then the user now requires accuracy and hence GPS coordinates provided to the SSAS and in other instances the SOCNETAP itself may be either rounded to 5, perhaps 6, decimal places or used to the fullest extend provided.

However, the other user's within the SOCNETAP whom are searched by the user may not at this point in time, or ever, wish their location to be determined at this level of accuracy but are still wanting to partake in the benefits that the SOCNETAP provides to users. However, within the prior art SOCNETAPs and other applications exploiting geo-location data there is no user selectable ability to either establish privacy such that their geo-location is hidden from all users, establish privacy from all users except those the user specifically enables such as through making them friends, or for them to select that there is visibility of their location but that it is general to the area and not specific. In the last instance this maintains privacy for the user whilst enabling benefit of the geo-location features of the application to be leveraged where these relate to other users having access to their approximate location or for the user having access to geo-location features themselves.

Accordingly, as depicted in first and second screen images 800A and 800B respectively in FIG. 8A a user accessing a SOCNETAP or other software application according to embodiments of the invention is provided with User Settable Privacy Pop-Up 830, part of a Privacy Module executing upon the user's PED, FED, or Internet based application which manages the settings, communications, etc. relating to the user settable privacy policy as well as will be discussed below in respect of embodiments of the invention interrupting and adjusting execution of the SOCNETAP and/or other applications. User Settable Privacy Pop-Up 830 allows for the user to set privacy settings. In first screen image 800A a user is provided with a simple option selection for showing their GPS location, set via first drop-down selector button 810, as a “YES” or “NO” option. Likewise second drop-down selector button 820 provides the user with similar “YES” or “NO” options for displaying their details. Accordingly, with first drop-down selector button 810 a user may elect to display their location or not during their use of the SOCNETAP directly or through a remote SSSA.

Referring to second screen image 800B the user of a SOCNETAP or other software application is provided with a more sophisticated option setting for their privacy with respect to geo-location. As depicted the user has an option to establish their profile as publicly visible, using selectable switch in first box 840, which in second screen image 800B indicated as set for visibility by the tick marker. Based upon that visibility selection additional options within region 850 are presented to the user with respect of the visibility of their location etc. As shown the user can select “Hidden”, “Approximate”, and “Exact” wherein the intermediate “Approximate” option is displayed with the statement that their location will be shown approximately 2-3 km from their real location. Third box 860 sets an aspect of the user's privacy policy wherein under the instance of the user having selected “Approximate” the message receipt radius is set to the same range so that the user only receives messages from those other users who are “proximate” to the user within this range.

Optionally, in second box 850 the user may be presented with a slider, or other selection means, allowing them to select from multiple “approximate” distances/offsets. Such options may include for example “100-200 m”, “500 m-1 km”, “2-3 km”, “10 km” as well as the “Exact” and “Hidden” settings. At 100-200 m a user may therefore indicate their presence within a particular area, e.g. within a pedestrian precinct downtown, a shopping mall, etc. At 2-3 km the user may be indicating a neighbourhood within a city or merely being within a small town. Accordingly, different settings for the “Approximate” range may be applicable for the user according to the particular circumstances they are in. Alternatively, instead of a slider the GUI may provide the option as another user interface, including, but not limited to, a drop-down menu, user dialog box, dial, and discrete buttons. Similarly, different options may be provided to the user for distances including their ability to specify particular distances or establish the applicability of these public visibility settings to all users of the SOCNETAP or whether to apply different ranges to different subsets of users. For example, as discussed below in respect of FIG. 3 as user may wish to have “Friends” and/or “Family” access their location at a different accuracy than general users of the SOCNETAP. For example, in the instance of SAM these “Friends” may be individuals whom the user has met through the SOCNETAP and would like to meet again such that providing increased location accuracy increases the likelihood of this occurring. In respect of “Family” these users may be shown the user's location at a different accuracy to “Friends” and all others within the SOCNETAP, which may in fact be the true location or one rounded to only a couple of meters. Within other embodiments of the invention the options for distance may be varied according to one or more factors including, for example, the speed the user is moving (which may be for example an averaged time—distance calculation), the application the user is using, the range of an activity within a SOCNETAP or other application, and user preferences.

Optionally, the privacy policy setting in third box 860 may be implemented as a slider allowing the user to set a different message receipt radius to that of their visibility and the range of the slider overall as well as minimum and maximum limits may be different to that provided in second box 850. For example the third box 860 may offer within “2-3 km”, “10 km”, “50 km”, “100 km”, “250 km”, “500 km”, and “Open to the World.” For example, the user may elect to receive messages from users within “2-3 km” of their location but only indicate their location within “100-200 m” or receive messages from users within “50 km” of their location but only indicate their location to within “500 m-1 km.” It would be evident to one skilled in the art that the approximate location may alternatively include the option for a user to enter an alternate location, e.g. the user may select Washington when they are in Baltimore or Berkeley when they are in San Jose. Optionally, the SSSA may apply an automatic randomization within a predetermined radius of the centre of the selected location, for example determined based upon a stored database which indicates a factor indicating size of locations such as for example city area (e.g. Washington is ˜185,000 km²), municipal area, length of location (e.g. Washington is ˜400 km²), width of location (e.g. Washington is ˜580 km²). Alternatively, the user may select the range such as described above in second box 850 and then either leave an associated field as “Current” or they enter a new “Location.”

Alternatively, instead of a slider the GUI may provide the option as another user interface, including, but not limited to, a drop-down menu, user dialog box, dial, and discrete buttons. It would also be evident to one skilled in the art that the user may within their profile associated with the SSSA providing geo-location services establish a privacy profile. For example, the user may wish that their position is approximate between 7 am and 9 am as they travel to work, hidden during working hours, visible but approximate 6 pm to 9 pm, hidden 9 pm to 7 am but is accurate Friday evening to Sunday evening. Alternatively with a GPS based automobile fleet management SSSA the automobile's location may be tracked with accuracy during business hours associated with the automobile or user of the automobile and then tracked approximately during non-business hours to provide privacy. For example, a salesman's location may be tracked during working hours but set approximately during non-business hours to a sufficient range to meet the conflicts of the user's privacy and the fleet owner's knowledge of their fleet's whereabouts.

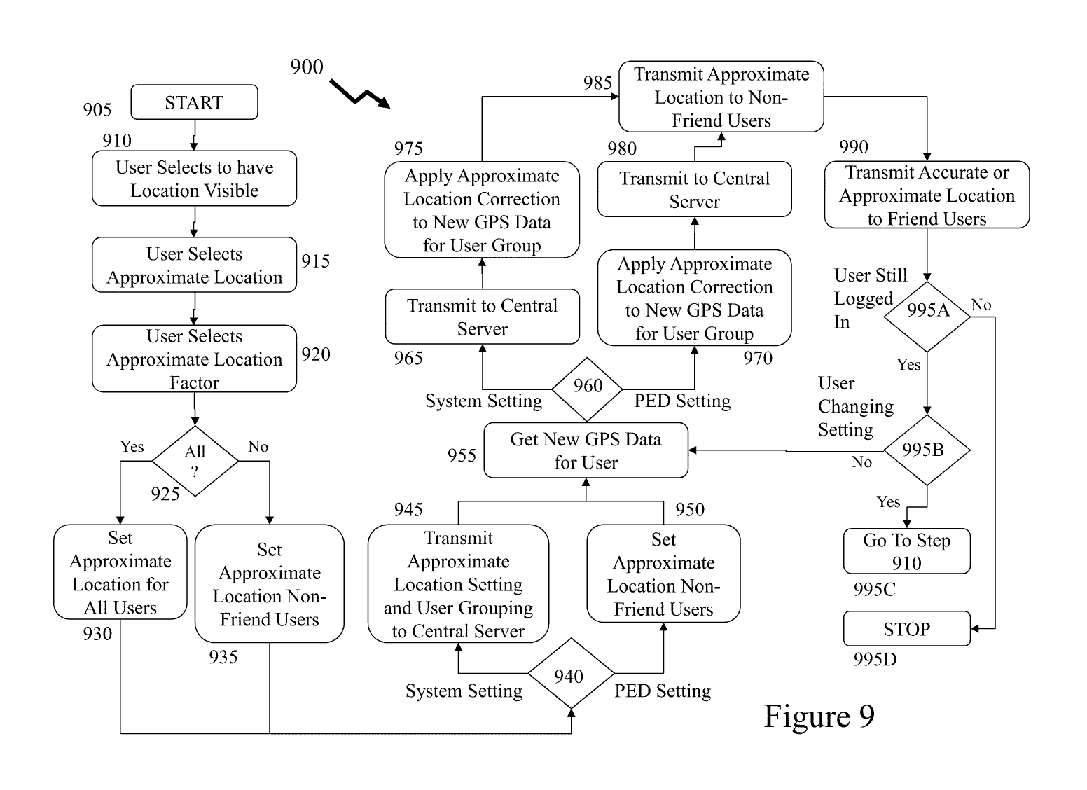

Now referring to FIG. 9 there is depicted an exemplary flowchart 900 for a user establishing privacy settings and these being applied by an application according to an embodiment of the invention. Accordingly, the process begins at step 905 and progresses to step 910 wherein the user selects within the application to have their location visible before in step 915 they select an approximate location option, such as described above in respect of FIG. 8 for example. Then in step 920 the user establishes the approximate location factor before in step 925 a determination is made, based upon a user preference or a user selection, as to whether the user wishes to apply the approximate location to all other users or only those users not within the user's “Friend” list. If a determination is made with respect to all users the process proceeds to step 930 otherwise it proceeds to step 935 wherein in each instance the appropriate setting is made within the application, e.g. a SOCNETAP, before proceeding to step 940 wherein a determination is made as to whether the settings in respect of privacy are to be applied locally by the PED of the user or by the SSSA. Based upon this determination the process proceeds to either step 945 or step 950. In step 945 the approximate location is transmitted to the remote SSSA together with the user grouping option selected by the user in step 925, whilst in step 950 the settings are established upon the user's PED. In each instance, the process proceeds to step 955 wherein new GPS data for the user is acquired.

In step 960 based upon whether the settings in respect of privacy are to be applied locally by the PED of the user or by the SSSA the process proceeds to steps 965 and 975 before proceeding to step 985 or via steps 970 and 980 before proceeding in step 985. In steps 965 and 975 the new GPS data is transmitted to the remote central server wherein the approximate location correction is applied to the user group established by the user previously in steps 925 through 935 respectively. In steps 970 and 980 the approximate location correction is applied to the user group established by the user previously in steps 925 through 935 respectively before the new modified approximate GPS data is transmitted to the remote central server. In step 985 the new modified approximate GPS data is transmitted to all non-friend users and then subsequently in step 990 either the accurate location data or the modified approximate GPS data is transmitted to all “friend” users before the process proceeds to step 995A.

In step 995A a determination is made as to whether the user is still logged into the application wherein if not the process proceeds to step 995D and stops. If they are still logged into the application then the process proceeds to step 995B wherein a determination is made as to whether the user wishes to change any settings (or has initiated a change in settings) wherein the process either loops back to step 910 via step 995C if they are making or wish to make changes otherwise it loops back to step 955 wherein new GPS data is acquired.

Optionally, a timer/delay step may be included within the loop such that GPS data is updated at a rate other than that of the GPS circuit within the user's PED. Optionally, this timer/delay may be established by the SSSA based upon one or more factors including, but not limited to, the approximate location range selected by the user, system preferences, range of search selected by system in dependence upon processing settings for other users in the region, wireless network connectivity, and PED battery status. It would be evident to one skilled in the art that the application may provide for multiple “contact lists” relating to different groups of “friends” wherein each may be subject to a different approximate location setting or some may be set to the same according to the preferences of the user. For example, a social media application exploiting geo-location may allow a user to set lists for family, buddies, friends, and acquaintances wherein family may be given accurate information, buddies and friends approximate location at a first level, e.g. 100-200 m for example, and acquaintances to approximate location at a second level, e.g. 2-3 km for example.

The approximate location factor established in step 920 may be simply a series of options presented to a user that match to defined rounding of the user's GPS location, e.g. “100-200 m”, “500 m-1 km”, “2-3 km”, “10 km” relate to 4, 3, 2, and 1 digit rounding by default. Alternatively, the GPS location may be employed in conjunction with their latitude (as equivalent distance of a degree varies with latitude) to define a rounding at a different level, e.g. rounding a given N^{th} digit to four levels, 0, 25%, 50%, 75% or 5 levels 0, 20%, 40%, 60%, 80% or 3 three bands such that if the value is between 0.86 and 0.24 it is rounded to “0”, 0.25 to 0.60 rounded to “0.5” and 0.60 to 0.85 is rounded to ‘0.75′’.

Now referring to FIG. 10 there is plotted a graph of the equivalent distance for a GPS coordinate rounded to different precision at two latitudes, 0° (Equator) and 40° (which crosses Spain, Italy, Greece, Tajikistan, Kyrgyzstan, China, North Korea, Japan, United States (California, Nevada, Utah, Illinois, Ohio, Pennsylvania, and New Jersey). As evident rounding a GPS location to 3 decimal places gives a longitude distance error of 110 m and 74 m respectively as these latitudes. At 60° latitude (which crosses Norway, Sweden, Russia, Alaska, Canada, United Kingdom) this distance error reduces to approximately 50 m. Accordingly, a rounding applied to a user in California, regions of China, etc. will generate double the approximate location offset as that applied in Canada or portions of the northern United Kingdom, Sweden and Norway.

Within the embodiments of the invention described above in respect of FIGS. 7A through 10 the approximate location is stated as being derived from a rounding, to a predetermined number of decimal places, being applied to the GPS data. Accordingly, a user at GPS 40.00000N; 105.40000W which is just south-west of Boulder, Colo. would have their GPS location unaffected for anything other than rounding to 1 digit. Rounding to 1 digit would yield 40.0N; 105.4W which would be the same as for users at 39.95N; 105.350W and 40.049N; 105.449W such that all users within a 10 km×10 km block selecting this privacy approximation would be rounded to the same GPS coordinate and hence presented to the other users top one another. This is evident in FIG. 11A wherein two accurate user locations 1110A and 1120A respectively are depicted upon a first map 1100A. After rounding to 2 digits their locations are atop one another as evident in second map 1100B with third and fourth approximate user locations 1110B and 1120B. Similarly, until either user moves sufficient distance for the rounding to change the result then they will be displayed stationary even if moving and their location will remain fixed until it jumps across the map to the next rounding if that is within the search range of the other user using the SSSA.

In some applications the user may wish to exploit approximate location but not have others aware that it is in use or if they do become aware to the extent the user has been seeking to hide their location. For example, a 100-200 m approximate distance setting if established by another user may trigger a different perception/reaction than when it is set to 2-3 km for example. Further, if another user viewing second map 1100B moves a cursor over the top of the apparently single pin then they will be provided, as within the prior art, with the name and image of the user whose pin is uppermost and be unaware that multiple pins are below. Accordingly, in another embodiment of the invention a user accessing a pin 1130 may be presented with an alternate icon which indicates the number of users at the same location such as icon 1140.

It would be evident to one skilled in the art that the approximate location generated for the user when selecting an approximate location may be established by applying, for example a mathematical process and/or algorithm, a correction to one or both of the latitude and longitude of the user's actual accurate position.

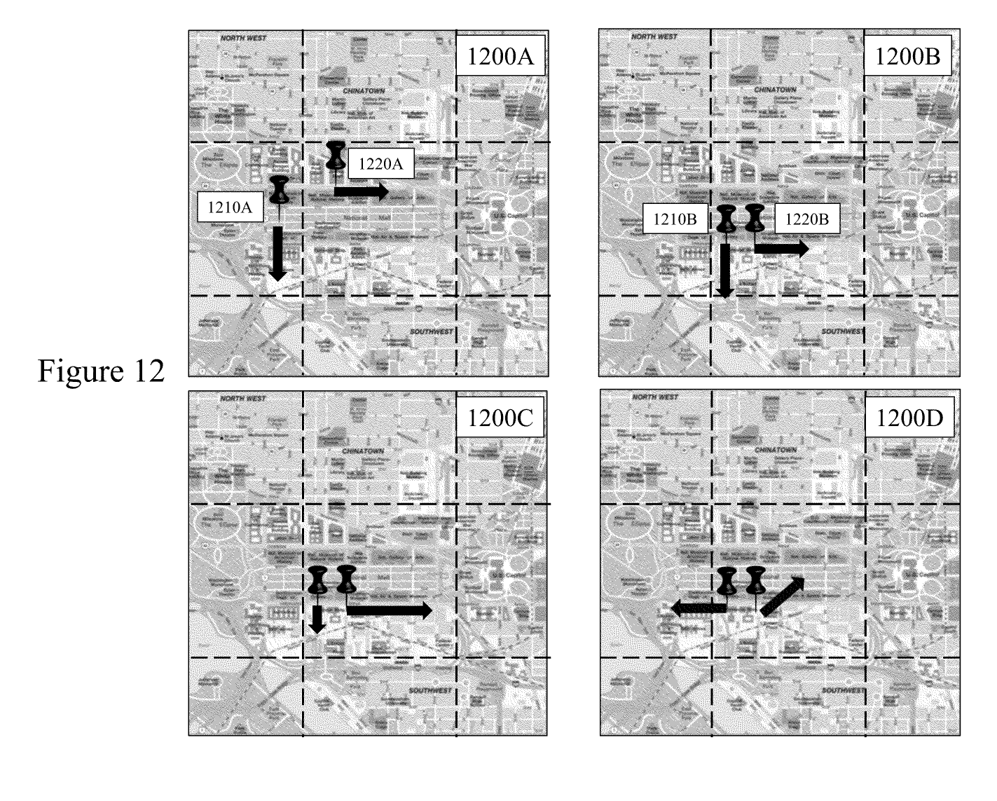

However, referring to FIG. 12 there is depicted an alternate methodology relating to approximate location as depicted within first to fourth result maps 1200A through 1200D respectively. Within first result map 1200A first and second accurate user locations 1210A and 1220A are depicted together with indications of their movement direction, which would not typically be evident to the user viewing the result maps but is provided for indicative purposes within this Figure. Each of the users establishes an approximate location, as discussed supra in respect of FIGS. 6A through 11, with 2 digits precision such that their location is being established within 500 m-1 km of their real location for example. However, as depicted in second result map 1200B the locations of first and second users are now displayed as third and fourth locations 1210B and 1220B respectively which are offset from their original accurate locations 1210A and 1210B respectively. Additionally these locations are updated in dependence of user movement so that their motion on the result screen of a user when it is updated, where it is updated at a relatively frequent rate, e.g. every minute, mimics that of their actual movements. However, as depicted in third result map 1200C these speeds of movement have been actually modified away from their true rates or as depicted in fourth result map 1200D have been actually changed completely.

It would be evident to one skilled in the art that these variations in apparent movement both in direction and/or speed may be user preferences associated with the approximate location feature established by the user or they may be established by the SSSA based upon one or more factors including, but not limited to, defaults; search result user density within the range indicated; physical barriers or limited access aspects of the environment which would prevent their motion or tend to direct their motion such as rivers, bridges, tunnels, no road, etc.; historical data such as typically users exit the business district in the evening or go towards it in the morning.

It would also be evident that a user in electing to replace the approximate location for themselves with an accurate location, so that another user they wish to meet through the SSSA can find them, may wish to similarly have the fact that they were previously using the approximate location feature hidden from the other user and in a similar manner as discussed in respect of FIGS. 11 and 12 does not wish to suddenly change location within the map presented to the user. Accordingly, in this instance as the user changes the selection the SSSA establishes the effective distance between the currently employed approximate location and their accurate location and therefrom a time base over which the user's location could be migrated to be compatible with a mode of transportation compatible with the location, e.g. walking, driving, public bus transport, rail transport, taxi etc.

Another user seeking to invade the privacy that a user establishes with the approximate location may seek to exploit the approximation feature which would essentially, when viewed by the other user on multiple occasions, place their “approximate” location in a distribution around their accurate location. For example, another user running repeated searches every couple of minutes for example would acquire a large number of “approximate” locations for the user during a relatively short period of time and subsequently repeat daily at a time the user may be anticipated to be at a predictable location, e.g. home in early morning, work during late morning, etc. Alternatively they may perform a large number of repeated searches within an hour or less. However, in either scenario the other user may with time increase their prediction of the user's accurate location. According to another embodiment of the invention the SSSA may remember an “approximate” location associated with the user such that repeated association of the user with an accurate location results in the SSSA replacing a process of approximate location setting with pseudorandom offsets from the accurate location with a stored “approximate” location such that another user's ability to infer the accurate location is reduced.

Within the descriptions associated with FIGS. 1 through 6 dating based SOCNETAPs were described exploiting geo-location based information to provide additional filtering options and real-time user whereabouts in respect of seeking those matching the user's search criteria. It would be evident to one skilled in the art that the provisioning of multiple service levels may be extended to include the privacy provisions and/or privacy policies either provided to a user or selectable by the user as options. For example, a user with a “Basic” account with a SOCNETAP service provider for example may be offered the privacy policy of blocking all user messages or allowing all user messages whilst being given “Hidden”, “Approximate” and “Accurate” geo-location options. In contrast a “Premium” account user may be provided with privacy policies that allow selection of a geographic range around them from whom messages may be received, only messages from other users they have contacted can be received, etc. in addition to those offered to the “Basic” account holder. Similarly, their geo-location privacy options may include “Hidden”, “Visible”, multiple levels of approximate location plus the ability to generate multiple user groups with different policies and location privacy settings associated with each.

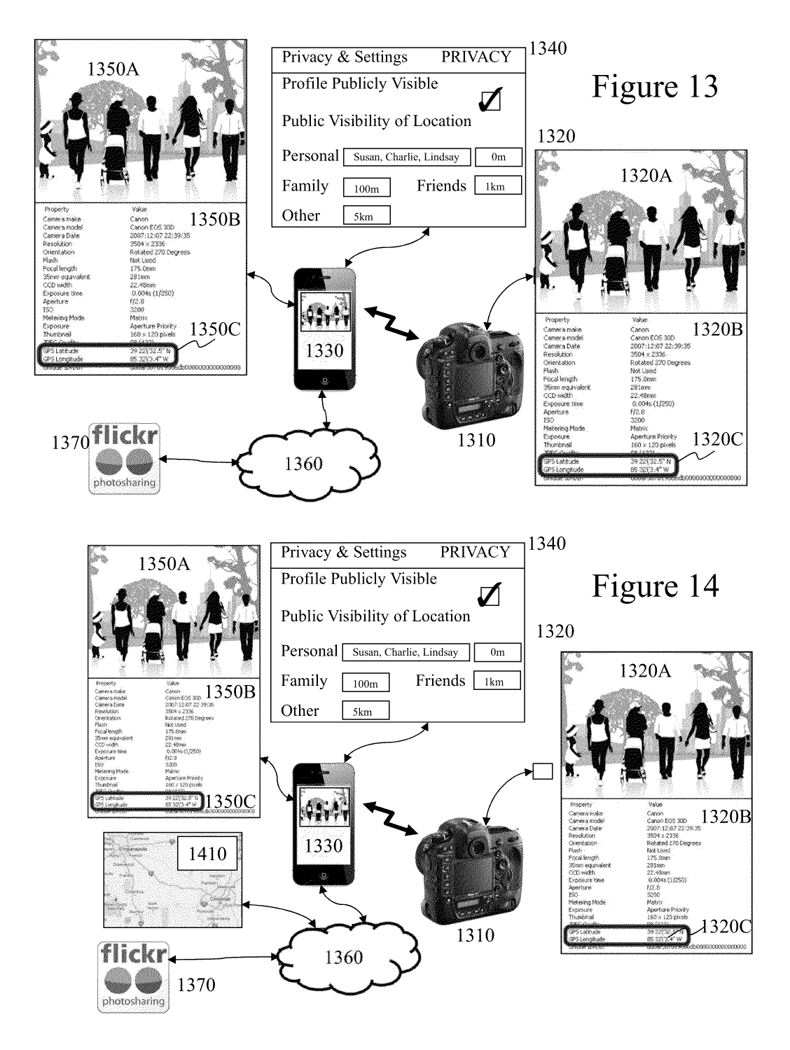

However, it would also be evident to one skilled in the art that a privacy policy software application, such as described supra in respect of a SOCNETAP or other applications, may also form part of other applications directly, provide data to and or modify data within another applications or applications, or be part of an operating system. Such an embodiment of the invention is described in respect of FIG. 13 wherein a Privacy Module 1340 forms part of an operating system upon a PED 1330 wherein the Privacy Module 1340 provides a user of the PED 1330 with privacy functionality in terms of approximating a user's location within other activities upon the PED 1330 other than social networks and/or social media such as described supra in respect of FIGS. 7A through 12. Accordingly, the user of PED 1330 acquires a digital image 1320 from their Digital Camera 1310 which is similarly GPS enabled as is the PED 1330. Accordingly, the camera 1310 embeds within the digital image metadata 1320B, which along with image 1320A forms digital image 1320, original geo-tag data 1320C relating to the geo-location at which the digital image 1320 was taken. As depicted the original geo-tag data 1320C is 39° 22′32.5″ N and 85° 32′3.4″ W which is just outside the town of Greensburg, Ind. When the digital image 1320 is received from Digital Camera 1310 the Privacy Module 1340 according to this embodiment does nothing. However, when the user seeks to upload the digital image 1320 to a web application 1370, e.g. Flickr™, then Privacy Module 1340 modifies the geo-tag data 1320C within the image metadata according to the privacy policy of the user stored within the Privacy Module 1340 for transmission via network 1360 to the web application 1370. Optionally, Privacy Module 1340 may adjust other aspects of the metadata including, but not limited to, user name, date of image acquisition, time of image acquisition, etc. discretely or in combination with the geo-tag modifications. Privacy Module 1340 may work upon other data acquired and then subsequently tagged by the user for transmission to a third-party service in order to adjust elements of that data to improve privacy of the user from an overall electronic footprint point of view.

Accordingly, the uploading of digital image 1320 to web application 1370 is interrupted by Privacy Module 1340 which generates a Modified Image 1350 comprising image content 1350A and modified digital image metadata 1320B which includes modified geo-data 1350C. Modified geo-data 1350C is 39° 20′32.5″ N and 85° 32′ 3.4″ W, which is about 4 km due south of the location the image was originally taken at as indicated by geo-tag data 1320C. Accordingly, the Modified Image 1350 is transmitted to web application 1370 via network 1360. It would be evident that within other embodiments of the invention the Privacy Module 1340 may be part of the Digital Camera 1310 allowing direct modification and transmission of the digital content by the user to web application 1370 via network 1360. Optionally, the Privacy Module 1340 may be a feature accessible to registered users of the web application 1370, a premium feature available to users of the web application 1370, or be a third party application that receives the content, modifies the metadata and then posts the content to the web application 1370. Examples of metadata that may include geo-tag data for still or video images include, but are not limited to, Exchangeable Image File Format (EXIF) or Extensible Metadata Platform (XMP) formats.

As depicted the Privacy Module 1340 comprises a toggle switch that provides for the user to make their profile publicly visible or not. When publicly visible the user may select different offsets for their public profile with respect to multiple classes of other users. For example, as depicted the user has Susan, Charlie, and Lindsay within “Personal” as being shown the user's exact location, for example these may be wife, son and daughter respectively. In the “Family” category users have been set to 100 m, whilst “Friends” and “Other” have been set to 1 km and 5 km respectively. The user groups for “Personal”, “Family”, “Friends”, and “Other” may be established in association with the SSSA or alternatively they may be associated with SOCNETAP or other application. Within an alternative embodiment of the invention the Privacy Module 1340 may include an option for the user to select SSSA or SOCNETAP, and in the latter instance which SOCNETAP. The offset ranges within Privacy Module 1340 may be selected by the user dynamically through Privacy Module 1340 or alternatively may be preset by the SSSA, SOCNETAP and/or other application.

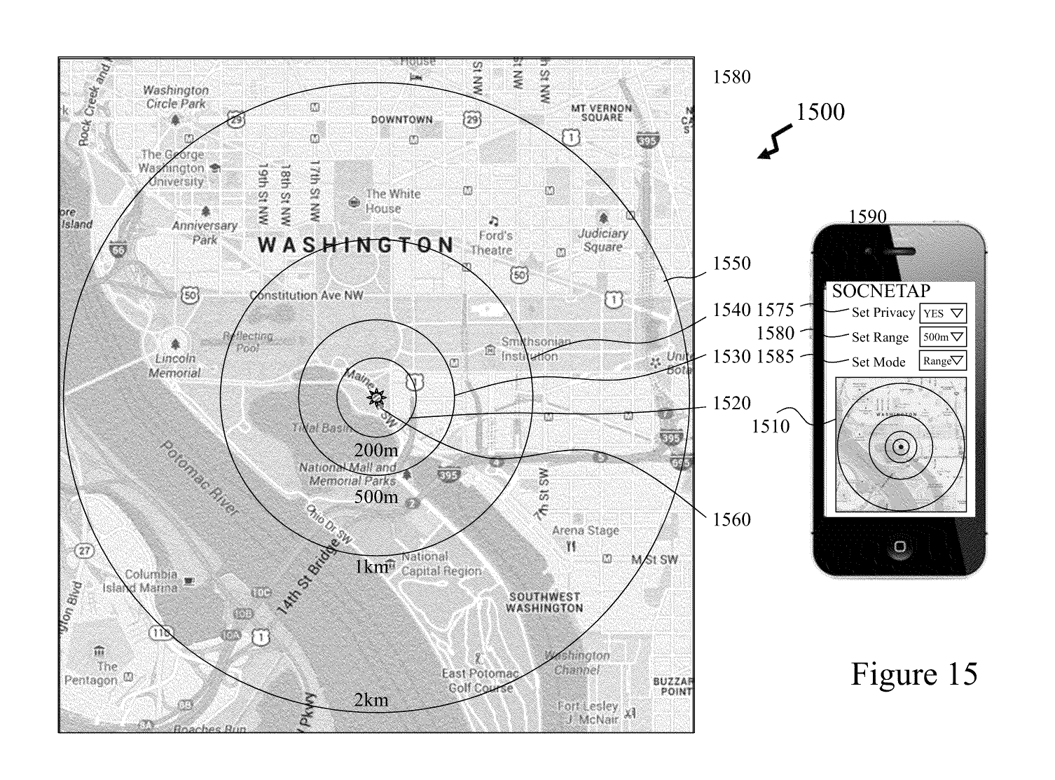

As similar scenario is depicted in FIG. 14 except that now the PED 1330 accesses an external third party application 1410 in order to obtain additional information as part of the process performed in conjunction with the Privacy Module 1340. For example, referring to FIG. 15 the user's PED 1590 executes the Privacy Module 1340 which displays a screen upon PED 1590 providing the user with options Set Privacy 1575, e.g. ON or OFF, Set Range 1580, e.g. 200 m, 500 m, 1 km and 2 km, and Set Mode 1585, displayed as Range but other options such as Tag, discussed below in respect of FIGS. 11A to 11C respectively, and Place, discussed below in respect of FIG. 12, may be offered as well as others. As discussed supra features such as Set Privacy 1575 and Set Range 1580 may be provided in different formats with different options. Also presented to the user is Geographic Data 1510 which as in Enlarged Image 1510 comprises Map 1580, for example extracted from a third party application 810 such as Google™, Yahoo™, Bing™, and MapQuest™ for example. Identified at the centre of Map 1580 is Locator Marker 1560 representing the current location of the user, and around this first to fourth indictors 1520 to 1550 respectively with radii 200 m, 500 m, 1 km, and 2 km respectively from the user's current location.

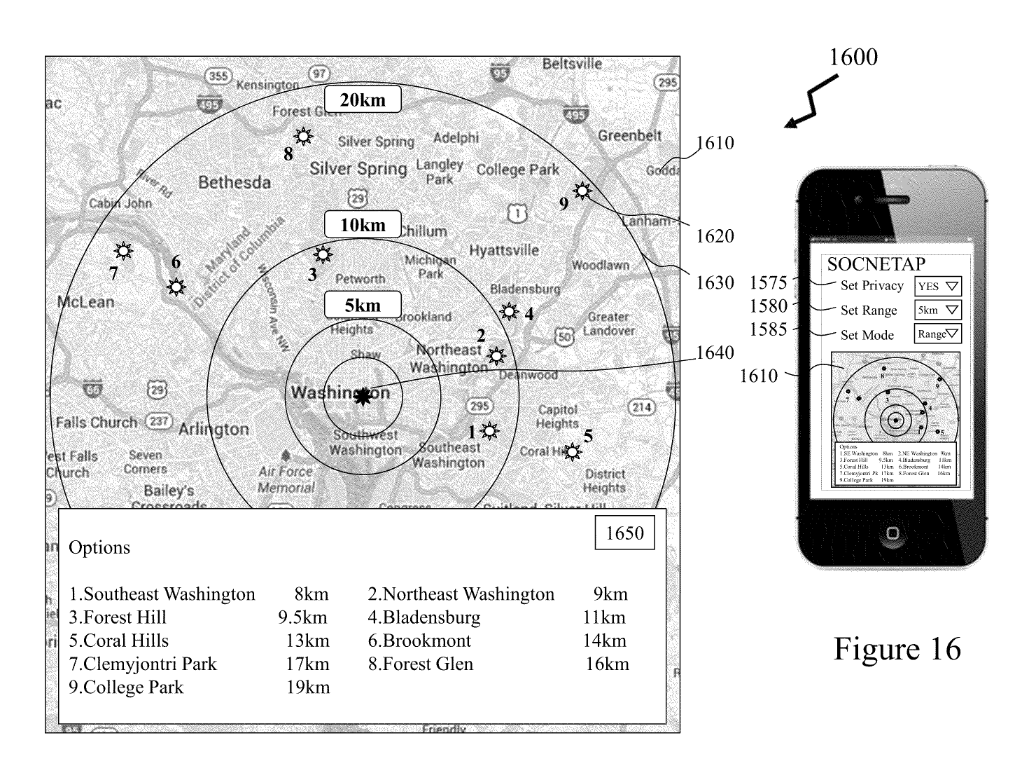

Accordingly, the user is able to visualize the area that the Privacy Module will move their location within, which is set currently by the user with Set Range 1580 is 500 m. If the user changes this, such as depicted in FIG. 16, to another value, e.g. 5 km then the displayed map changes, now depicted as Map 1610 but maintaining the user location marker 1640 and range markers, including 20 km Range Marker 1630. The Privacy Module may automatically establish an offset location such as described supra in respect of FIGS. 2 through 6 respectively or it may according to user preferences, predetermined defaults, user selections, etc. present a series of options to the user that meet particular characteristics. For example, this preference may be to match location characteristics such as depicted in FIG. 16. In this instance Privacy Module determines from the third part application that the user is currently in a green space environment and presents to the user a plurality of green space options such as denoted by Alternate Location Marker 1620 together with Table 1650. Hence, the user may select “9. College Park.” It would be evident to one skilled in the art that a user within a particular environment, e.g. green space, may find it easier to talk to other users who are being shown the user's current location as “9. College Park”, rather than actual downtown Washington, when it matches their actual environment. Similarly, posting an image of green space within a SOCNETAP for example with the associated text “Saturday . . . Just chilling in the park” with modified geo-tag data maintains the perception as even if another user access the geo-tag data and maps it then it will appear as a park or green space, rather than the middle of the Potomac River or Reagan National Airport for example.

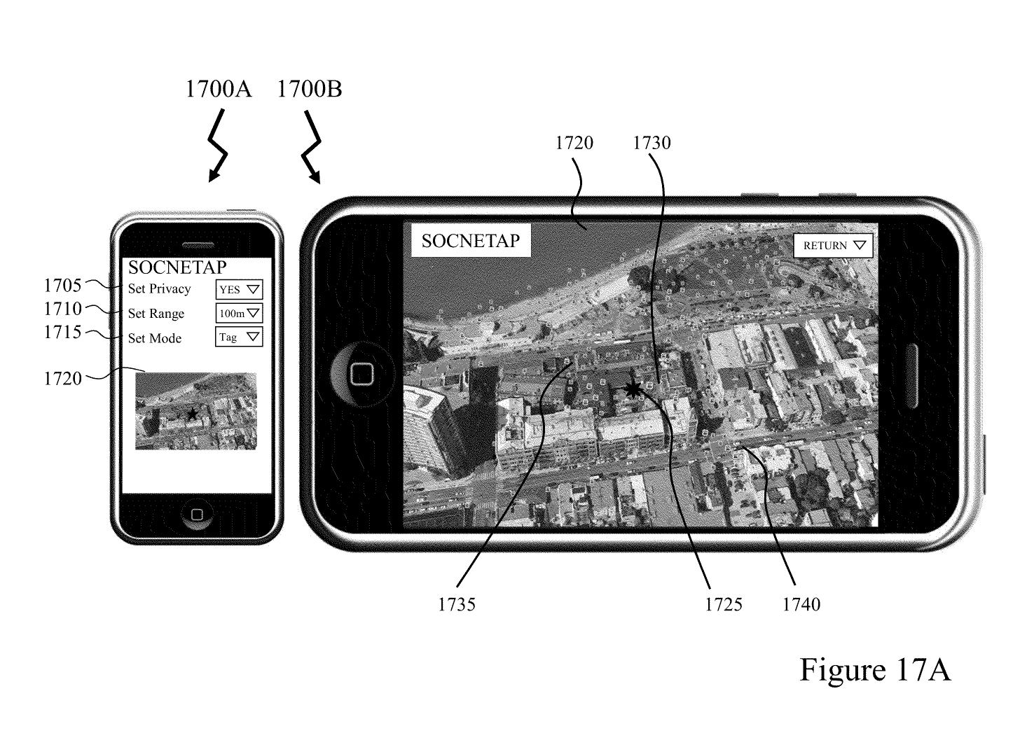

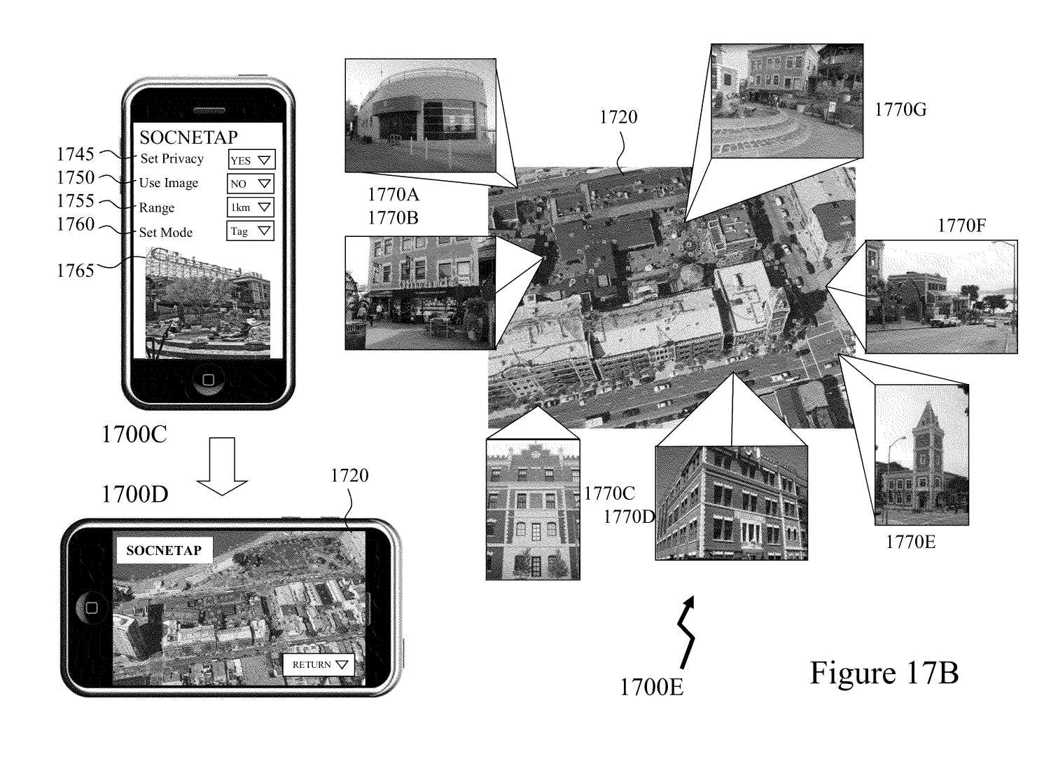

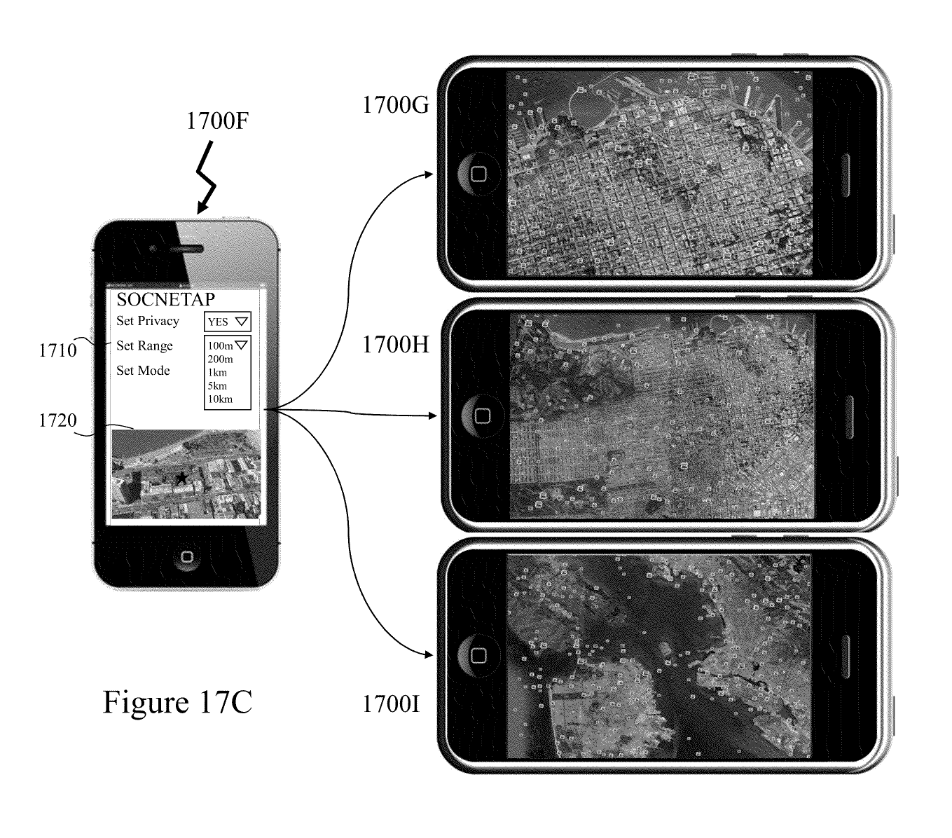

Now referring to FIG. 17A there are depicted first and second PED Images 1700A and 1700B relating to a PED upon which a user is executing a Privacy Module. In first PED image 1700A the user is presented with a screen providing selection options such as Set Privacy 1705, e.g. ON or OFF, Set Range 1710, e.g. 100 m, 200 m, 500 km and 1 km, and Set Mode 1715, displayed as Tag but other options such as Range and Place but others may be offered. Also displayed is area image 1720 which has been retrieved from a third party application, in this instance Google™ Earth. If the user selects the image, e.g. by touching the screen in that region, the screen changes to that depicted in second PED image 1710B wherein the area image 1720 is displayed together with location indicator 1725. Also depicted on area image 1720 are a plurality of icons, of which first to third icons 1730 to 1740 are depicted. Each of the plurality of icons having been also retrieved from third party application although it would be evident that these may be also retrieved from one or more third party applications including, but not necessarily, the third party application providing the area image 1720. It would be evident that with some third party applications in combination with the capabilities of the PED, e.g. touch-screen that the user, would be able to adjust the scale of the image, move the location etc. wherein these adjustments would also be tracked by the Privacy Module such that selections made by the user are tracked, monitored, and employed within the actions of the Privacy Module such as described below in respect of FIG. 17B and 17C as well as other embodiments of the invention.

For example, the user may simply elect to tap the screen at a location wherein the user through additional actions via the keyboard and/or pop-up menus makes the selected location the new location which the Privacy Module uses to transmit/employ in order to provide the user with the desired level of privacy as to their location rather than this being established automatically by the Privacy Module based upon the range selected by the user etc. such as described supra in respect of FIGS. 7A through 16 respectively. Alternatively, as depicted in FIG. 17B the user has recently taken a photograph 1765 which they were intending to post to a SOCENTAP or other application. However, whilst the modification of the geo-tag data within the photograph 1765 as discussed supra in respect of FIGS. 13 and 14 may be employed it would be evident that in many instances, such as photograph 1765, the content of the image is location specific, in this instance the “Ghirardelli” identifies the photograph as being taken at the Ghirardelli chocolate factory in Ghirardelli Square, San Francisco. Accordingly, it would be evident that adjusting the geo-tag data leads to the potential disclosure of the user's use of the Privacy Module as if the geo-tag data is mapped the location will not align to that the user is currently shown at or obviously conflicts with a comment posted alongside the photograph 1765.

Accordingly, in FIG. 17B first PED image 1700C the user is accessing the Privacy Module with the previously described Set Privacy 1745, Range 1755, and Set Mode 1760 features. However, as the Privacy Module is aware of the user posting an image whilst the Privacy Module is active it also displays the photograph 1765 and a Use Image 1750 selector for the user, e.g. with YES and NO options. In this instance if the user selects “YES” then the image is employed but if the user selects “NO” then the Privacy Module transfers to second PED image 1700D wherein a regional map, e.g. area image 1720, is presented to the user extracted from a third party application. Optionally, a conventional map image is presented atop which icons, e.g. the first to third icons 1730 to 1740 respectively as discussed in respect of FIG. 17A are presented to the user. As depicted in image set 1700E area image 1720 is displayed together with first to seventh images 1770A to 1770G respectively which, for example, may be displayed to the user upon the user selecting an icon within area image 1720. As previously described the user may exploit features of the PED to zoom, move, select in order to determine an acceptable image and location in order to replace the photograph 1765 for the posting being made by the user. As discussed previously, if the user zooms out, moves etc. then the Privacy Module tracks these changes and selects accordingly the appropriate area image 1720.

Now referring to FIG. 17C first PED image 1700F is presented wherein the user has selected to adjust the range via Set Range 1710 wherein options presented to them include, for example, 100 m, 200 m, 1 km, 5 km, and 10 km. As the user scrolls and/or selects a range then the area image 1720 presented to the user adjusts dynamically, or upon selection. Accordingly, when selecting the area image 1720 the user is provided with images such as depicted in second to fourth PED images 1700G to 1700I respectively wherein the area map reflects the range selected by the user and the icons therefore reflect locations at distances commensurate to the range as well as others within that range. Accordingly, the user may select an image and at the same time select a new location that the Privacy Module will employ subsequently until modified or turned off by the user.

As presented supra in respect of FIGS. 17A through 17C a user may select a location and image for posting (publication) to a SOCNETAP and/or another application through an external application interfacing to the Privacy Module. Such an external application may, for example, be Google™ Earth which provides mapping and geo-tagged information within a single application/portal for Internet access and retrieval. Optionally, However, it would evident that one or other applications/Internet sources may provide the same required functionality or that content may be extracted and/or merged based from a plurality of other applications/Internet sources. It would also be evident that in instances where the user is selecting a range and their current location is a famous or well-known one, as established by the Privacy Module using their real GPS location that the Privacy Module when detecting that the user wishes to post an image may extract images from another application/Internet portal that does not provide geographic mapping or where the another application/Internet portal does provide geographic mapping present the alternate images in an alternate format than that discussed supra in respect of FIGS. 17A through 17C.

Such an example is depicted in FIG. 12 wherein first PED image 1200A depicts a similar scenario to that discussed above in respect of first PED image 1700A in FIG. 17A. In this instance the user is again presented with Set Privacy 1205, Set Range 1210, and Set Mode 1215 but in this instance has selected “Place” wherein Location 1220 is displayed together with the image 1225 the user was going to post. As depicted Location 1220 contains an identifier, in this instance “Sacre-Coeur, Paris, France” together with verification field, e.g. YES or NO. In this instance depending upon the range selected the displayed screen to the user is one of second and third PED images 1200B and 1200C respectively. With each of these the user is presented with Location Field 1230 and Set Range 1235 allowing them to adjust these settings based upon the content provided to them with the second and third PED images 1200B and 1200C respectively. In each of these images are presented to the user commensurate with the range selected by the user wherein these are filtered based upon geo-tag data to either be within a zone surrounding the current user location, e.g. an annulus 250 m-500 m or 300 m-750 m where the user has selected 500 m, or unfiltered. Accordingly, in second PED image 1200B where the selected range is 500 m the images are close to the Sacre-Coeur whilst in third PED image 1200C with the range increased to 2 km the images are of the Sacre-Coeur in the distance. It would be evident that such an approach as described in respect of FIG. 12 may be employed in the process described in respect of FIGS. 17A through 17C. In this manner the user rather than being presented with an area map, e.g. area map 1720, and icons, e.g. first to third icons 1730 through 1740 respectively, the user would simply be presented with first to seventh images 1770A through 1770G respectively.

Within the descriptions supra in respect of embodiments of the invention described in FIGS. 7A through 18 and notably FIG. 12 that the Privacy Module provides for a user to selectively adjust their location away from their true location by adjusting the GPS location employed in transmitting user data to a SOCNETAP or other software application/portal. In some embodiments of the invention this is performed automatically by the Privacy Module whilst in others the user may dynamically select it. One such example is the replacement of content being posted to a social media website wherein the user selects a replacement item of content to the one they have themselves taken as this if posted would reveal their location with reasonable accuracy due to its fame or being known to those reading the user's post(s). Within the automatic establishment of the offset from their true location and the subsequent generation of variations in apparent movement both in direction and/or speed to either mimic user movements or discretely remove the offset without alerting another user that it had been employed one or more factors established by the SSSA were identified as potentially forming part of the determinations. One of these was physical barriers or limited access aspects of the environment which would prevent the user's motion or tend to direct their motion such as rivers, bridges, tunnels, no road, etc. However, it would be evident that similar geographic boundaries/barriers would also provide the means for selectively filtering content and/or options provided to the user.

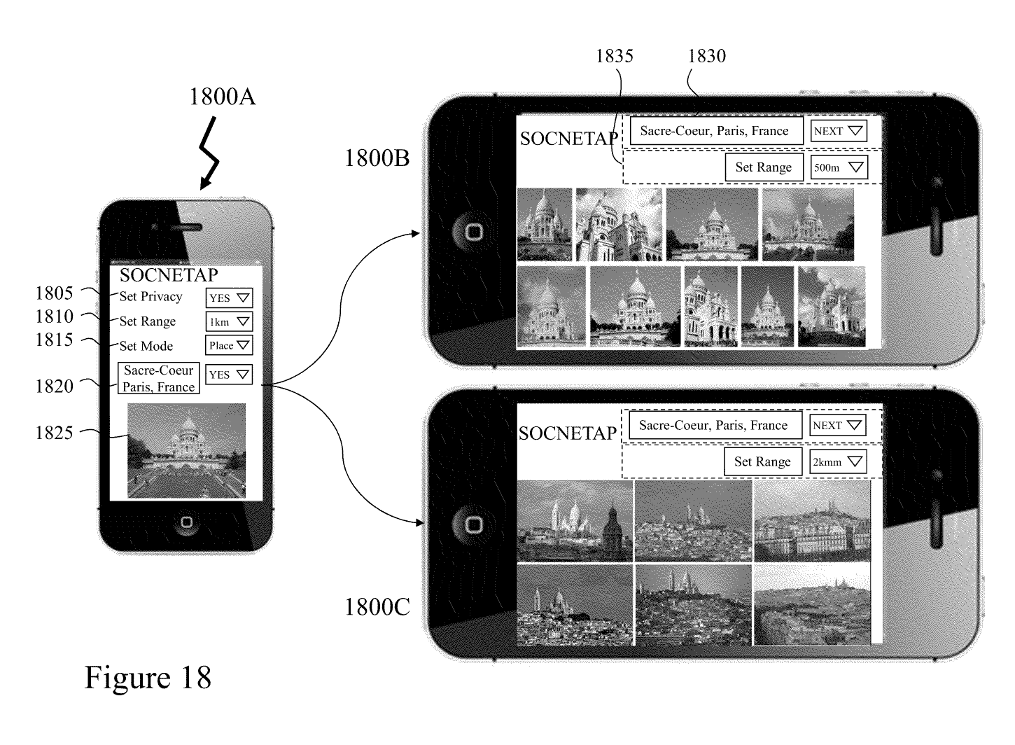

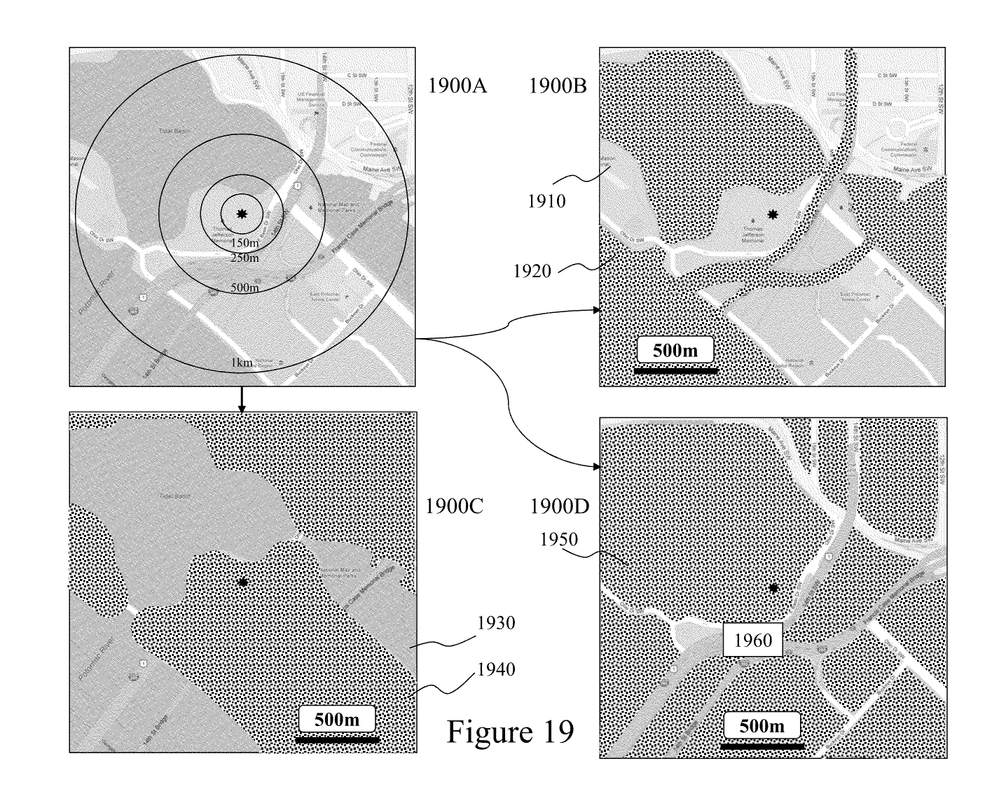

For example, a user who posts content stating that they are travelling on the highway should not, ideally, replace their true location with one that conflicts with this statement nor select alternative content to post, e.g. photograph such as described in respect of FIGS. 17B and 18 for example. Accordingly, the Privacy Module when extracting information from a third party application or other application, such as geographic and/or geo-tagged information/content may filter this prior to display based upon user input or analysis of user content/activity. For example, referring to FIG. 19 there is depicted such a process displayed by results rather than process flow. Referring to FIG. 15 a user was presented a Map 1580 with a Locator Marker 1560 representing the current location of the user, and around this first to fourth indictors 1520 to 1550 respectively at predetermined radii from the user's current location. Accordingly, first map 1900A in FIG. 19 depicts this basic scenario wherein absent any other filtering the user is simply presented the map and indicators of radial distance. In contrast, in second map 1900B the area has been blocked into allowed zone 1910 and blocked zone 1920 based upon, for example, the user is moving at low speed, e.g. walking/jogging/running, or is stationary using time based GPS data; that they are seeking to post content containing a predetermined keyword such as park, restaurant, street, etc.; that content they wish to post or replace contains an image analysed and assessed as matching a predetermined environment, e.g. park, street scene, etc.; and a selection made by the user as part of the configuration settings of the Privacy Module.

Alternatively, in third map 1900C the user has by one of these methods or another indicated that they are on a boat and accordingly within third map 1900C those areas identified as water 1930 are accessible for location determination but those within land 1940 are blocked out. Similarly, in fourth map 1900D the user has by one of these methods or another indicated they are driving above a predetermined threshold or are stuck in traffic wherein those areas identified as highway 1960 are accessible for location determination but those within city 1950 are not. Accordingly, the actual location established by the Privacy Module may be automatically determined by the SSSA or by the user based upon this allowed/blocked zone information alone or in combination with other data and/or user selections.

Within the descriptions supra in respect of embodiments of the invention and FIGS. 7A through 19 respectively emphasis has been placed primarily upon the user and/or SSSA processes for establishing the offset location and maintaining use of the Privacy Module as hidden from the other user being given the offset user location. However, in respect of FIG. 9 it was established with decision step 925 whether the offset location is to be provided to all users or only those users that were not within the user's “Friend” list. It was also established that a SOCNETAP or other application may provide for multiple “contact lists” relating to different groups of “friends” wherein each may be subject to a different approximate location setting or some may be set to the same according to the preferences of the user. For example, a social media application exploiting geo-location may allow a user to set lists for family, buddies, friends, and acquaintances wherein family may be given accurate information, buddies and friends approximate location at a first level, e.g. 100-200 m for example, and acquaintances together with all other users are given an approximate location at a second level, e.g. 2-3 km for example.

However, in many instances a user may wish to use the Privacy Module in conjunction with multiple SOCNETAPs and/or other applications leading potentially to a user being in two contact lists but with different settings, i.e. acquaintance in one and friend in another. Hence, the user may toggle between these two applications and notice that the user's location is different within each. Accordingly, in some applications the Privacy Module provides for a coordination of multiple contact lists such that a request from a SOCNETAP or other application for location data of the user is parsed by the Privacy Module and not solely by the SOCNETAP or other application. Accordingly, the Privacy Module may extract, merge, and consolidate contact lists as well as prompting the user to resolve conflicts, differences etc. Optionally, the Privacy Module may interact further with the SOCNETAP or other application and modify the contacts to match that within the Privacy Module. The Privacy Module may therefore also manage 3 or more levels of contact for the user. However, where the user is posting content issues arise with conflicts in essentially the reverse wherein content with adjusted geo-tag data or content does not now match the location provided to friends, family etc. Optionally, the user may elect to select one SOCNETAP or other application as the master contact list such that status of a contact within the Privacy Module to be pushed other SOCNETAPs or other applications is determined by this SOCNETAP or other application.

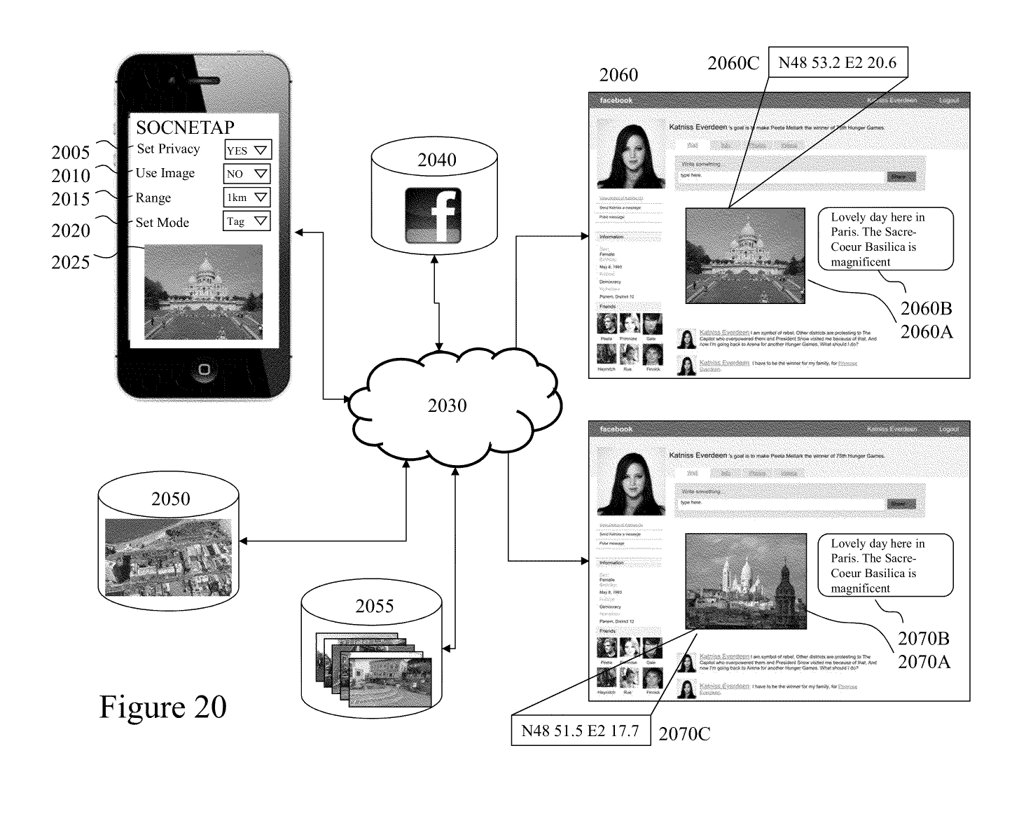

Accordingly, referring to FIG. 20 a SOCNETAP or other application, Application 2040, e.g. Facebook, receives content from a user's PED. As before a Privacy Module provides the user with options including Set Privacy 2005, Use Image 2010, Range 2015, and Set Mode 2020 wherein “Tag” has been selected with respect to Original Image 2025 of the Sacre-Coeur Basilica in Paris, France. As discussed supra in respect of FIGS. 17A through 12 the Privacy Module may access third party applications and/or databases such as Geographical Application 2050 and Image Database 2055 in order to establish either an alternate image that matches an offset location or establish the offset position in dependence upon the image selected. When the user posts the content to the SOCNETAP or other application both images and associated GPS location data are transferred to the Application 2040. Subsequently, a first contact, with family status in the contact list accesses the SOCNETAP or other application and is presented with information in first SOCNET screen 2060 which has first image 2060A and first posting text 2060B. As the first contact is family then the first image 2060A matches Original Image 2025 and if geo-tag data was accessed within a short period of time from the posting the coordinate data 2060C (N48 53.2 E2 20.6) would be close to the GPS location of the user within another SOCNETAP or other application.

If a second contact, with acquaintance status in the contact list accesses the SOCNETAP or other application and is presented with information in second SOCNET screen 2070 which has second image 2070A and second posting text 2070B. As the second contact is an acquaintance then the second image 2070A does not match Original Image 2025 but rather is that selected in response of the processes described supra in respect of FIGS. 17A through 18 based upon the settings of User Image 2010 and Set Mode 2020. Now, if the geo-tag data was accessed within a short period of time from the posting the second coordinate data 2070C (N48 53.2 E2 20.6) would be close to the GPS location of the user within another SOCNETAP or other application for acquaintances, roughly 2 km from that of those with family status who are provided first coordinate data 2060C (N48 53.2 E2 20.6). Accordingly, postings may be managed within different applications to provide a consistent offset location. Optionally, the second image 2070A and second posting text 2070B may be removed/replaced with the first image 2060A and first posting text 2060B after a predetermined period of time or left. Optionally, the second image 2070A and second posting text 2070B may be associated with other postings within a period of time and/or geographic region such that all of these are transitioned to the original postings together or left permanently at their offset locations.

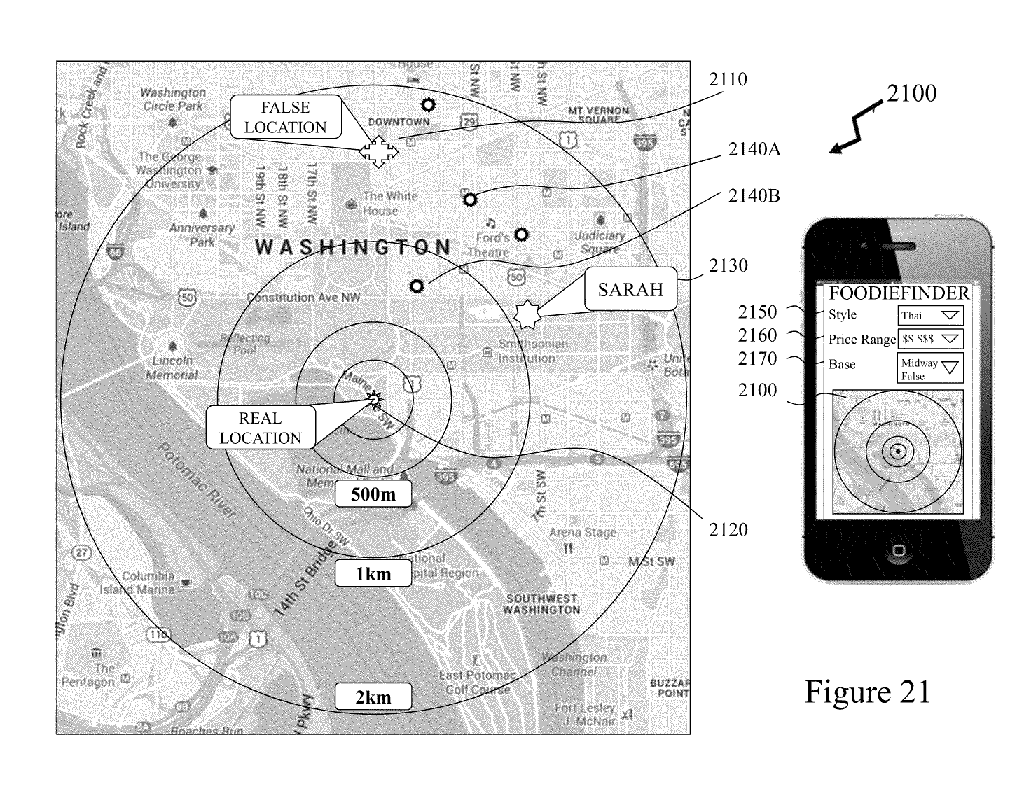

Now referring to FIG. 21 there is depicted a Map 2100 presented to a user of a PED employing a SSSA such as described supra in respect of providing a Privacy Module and displaying the user's position as being different to their true location by some approximation or offset based upon system, software and/or user preferences. Accordingly upon Map 2100 are shown “False Location” 2110, representing the location presented to another user based upon the user identity and user settable settings, in this instance, as close to the White House in downtown Washington. Also depicted are “Real Location” 2120 and “Sarah” 2130 representing the true location of the user and the indicated location of another user. As depicted Map 2100 is presented to the user upon their PED within an application “FOODIEFINDER” which presents to the user a series of options relating to Style 2150, e.g. “Thai”, Price Range 2160, e.g. “$$-$$$” representing moderate pricing, and Base 2170, e.g. “Midway False.” Accordingly, displayed upon the Map 2100 are first and second Restaurants 2140A and 2140B respectively which fulfill the filter both in terms of Style 2150, Price Range 2160, Base 2170 and the geographic location between the “False Location” 2110 and “Sarah” 2130. It would be evident that other options for Base 2170 may include “My Real” and “Their Location” as well as a geographic search disassociated with any of “False Location” 2110, “Real Location” 2120 and “Sarah” 2130. Accordingly, the user within the application “FOODIEFINDER” may select a restaurant apparently close to both themselves and the other user and establish a time commensurate with their travel from their real location to the selected restaurant.

Optionally, as the user browses selecting first and second Restaurants 2140A and 2140B they may be provided with travel times by one or more means such that when communicating their option, e.g. first Restaurant 2140B, they may indicate how long they will take to arrive. Based upon user preferences, e.g. bus, metro, drive, etc. the restaurant selected may be first Restaurant 2140A even though it is further from their “Real Location” 2120 as it is closer to a Metro station, for example, than second Restaurant 2140B. Optionally, the options presented to the user may be colour coded in dependence upon travel time for example such that selecting the appropriate option is a faster process. It would be evident that if the user selected another option under Base 2170, e.g. “Midway—True”, “True”, “Other User” then the mapping of returned search results would adjust.

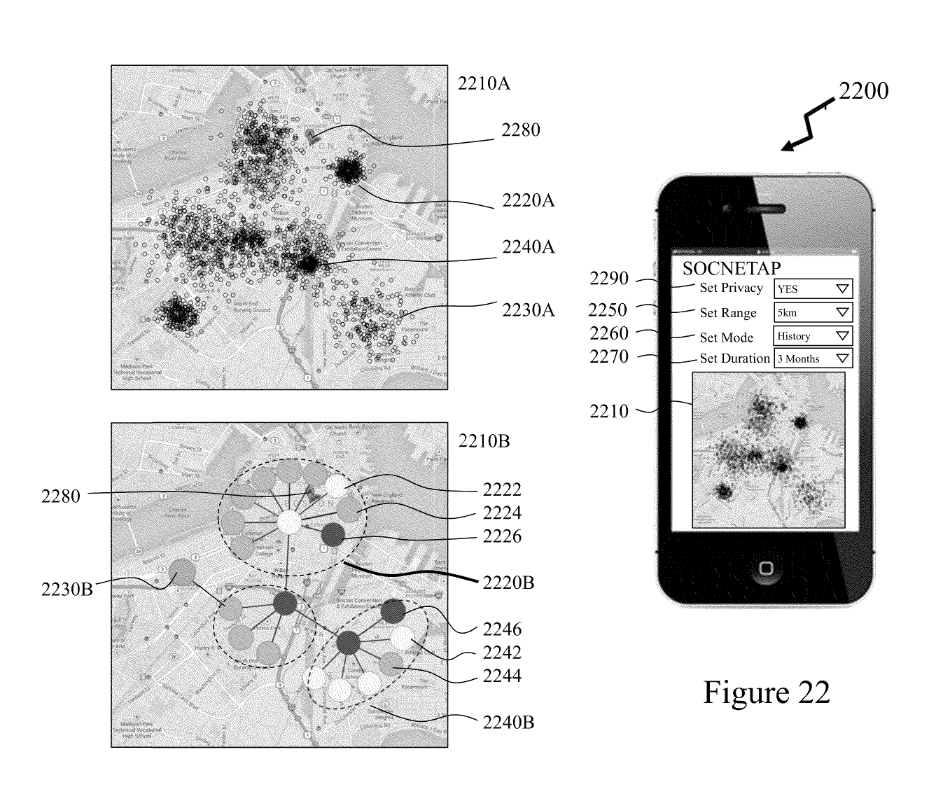

Now referring to FIG. 22 there is depicted according to an embodiment of the invention a method wherein a user is presented with additional information whilst making a determination of an offset location for use within a Privacy Module in association a SOCNETAP such as described supra in respect of FIG. 7A through 21 above. As depicted in SOCNETAP screen image 2200 a user has selected upon their PED to modify their Privacy Module settings within a SOCNETAP wherein they are shown a Map 2210 together with a series of options relating to Set Privacy 2290, e.g. “Yes”, Set Range 2250, e.g. “5 km”, Set Mode 2260, e.g. “History” representing that the user wishes to exploit historical data, and Set History 2270, e.g. “3 Months” representing that the user wishes to use data from their activities over the past 3 months. As depicted in first Map 2210A the user is presented with a cluster view of their historical location within a zone determined by the range selected through Set Range 2250 wherein the cluster data has been aggregated over the 3 month time frame established through Set History 2270. Accordingly the first Map 2210A depicts the user's Current Location 2280 together with cluster data including, for example, first and second clusters 2220A and 2240A representing areas of high frequency and isolated occurrences 2230A.

The data for the cluster analysis may, for example, be automatically acquired by the user's PED with a periodic location sampling, e.g. every 5 minutes, based upon triangulation such as those based upon satellites, e.g. GPS, or wireless base stations, e.g. RSSI triangulation. Accordingly the user may select a location by tapping the touchscreen of their PED to select their offset location. Use of a stylus rather than a finger may improve accuracy or the user may zoom into the map for a more detailed view. In this manner the user may select an offset location that fits their personal habits. It would be evident to one skilled in the art that the cluster analysis may be further refined in that the analysis is time and/or day specific such that a cluster analysis run at 6 pm Saturday will present different clusters to that run at 1 pm Tuesday.

Now referring to second Map 2210B there is depicted an alternate view of cluster analysis presented to a user wherein a stylized cluster analysis rather than relatively raw data is presented to the user. Accordingly, the second Map 2210B presents first and second clusters 2220B and 2240B which are each divided into frequent nodes 2226/2246; common nodes 2224/2244; and occasional nodes 2222/2242 within each of the main clusters. Also depicted are isolated nodes 2230B. In this manner the user is presented with a second stage cluster analysis as a cluster, e.g. first cluster 2220A in first Map 2210A, is shown as first cluster 2220B with a plurality of nodes within. In some embodiments of the invention these nodes may be labelled either automatically, such as by linking locations to mapped areas, e.g. Google Maps, or through a labelling process with input from the user. The user may therefore simply select a node, e.g. by tapping it, or a cluster, e.g. by circling it, or alternatively select another location on the map or decide to change the setting within the SOCNETAP, e.g. Set Range 2250 and/or Set Mode 2260.

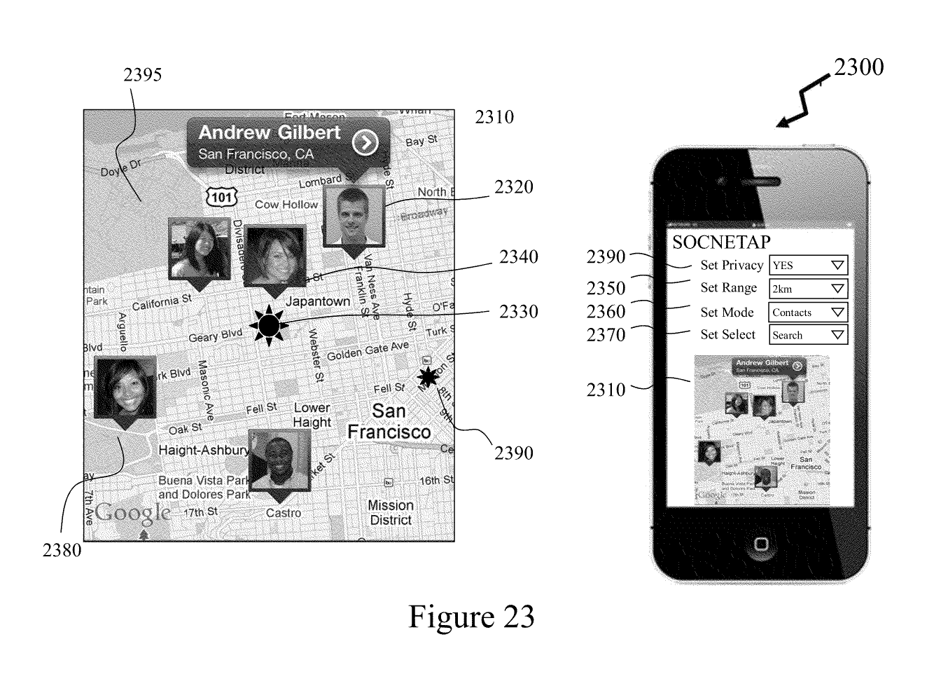

Now referring to FIG. 23 there is depicted according to an embodiment of the invention a method wherein a user is presented with additional information whilst making a determination of an offset location for use within a Privacy Module in association a SOCNETAP such as described supra in respect of FIG. 7A through 21 above. As depicted in SOCNETAP screen image 2300 a user has selected upon their PED to modify their Privacy Module settings within a SOCNETAP wherein they are shown a Map 2310 together with a series of options relating to Set Privacy 2390, e.g. “Yes”, Set Range 2350, e.g. “2 km”, Set Mode 2360, e.g. “Contacts” representing that the user wishes to select an offset based upon the locations of contacts exploit historical data, and Set Select 2370, e.g. “Search” representing that the user wishes to use data from their search activity. Other options may, for example, include “Family”, “All”, or “Friends”. Accordingly within Map 2310 the user is presented with a map of the area at the scale they selected, as defined by the Set Range 2350, upon which is indicated their location 2330 together with the locations of first to third individuals 2320, 2340 and 2380 respectively arising from the user's search. Also indicated is suggested location 2390 which is suggested by the Privacy Module within the SOCNETAP based upon one or more rules established either by the SOCNETAP and Privacy Module alone or in combination with data/settings relating to the user, e.g. furthest from all individuals in the user's search within the range selected. Accordingly, the user may select the suggested location 2390 or select another location. If the user was going to make use of other features of the Privacy Module according to embodiments of the invention such as locating themselves to a park and posting a picture of the park then the user now knows that third individual 2380 is within one park within the region of their selected range and hence to select another park, e.g. park 2395.

Within the description supra in respect of embodiments of the invention and FIGS. 7A through 21 a user may provide offset locations via a Privacy Module that forms part of the operating system of their PED, forms part of a SOCNETAP or other application in execution upon their PED, forms part of an Internet accessed SOCNETAP or other application, is a discrete application in execution upon their PED, or an Internet accessed application. These descriptions have been described from the viewpoint of a dynamic assignment of new locations etc. by the user with subsequent motion tracking to reflect their movements. Such offset locations may be applied for a short period of time or over an extended period of time according to the user's requirements. As described supra the Privacy Module within or associated with a SSSA, SOCNETAP or other application may remember an “approximate” location associated with the user for a predetermined period of time such that repeated association of the user with an accurate location results in the SSSA replacing the process of approximate location setting with pseudorandom offsets from the accurate location with a stored “approximate” location. This may limit the other user's ability to infer the accurate location. However, over an extended period of time multiple stored “approximate locations” may be acquired by a third party and analysed. Accordingly, where the Privacy Module is used over an extended period of time the Privacy Module may exploit one or more techniques within the prior art, e.g. clustering, to associate a plurality of GPS coordinates to one location, e.g. home, office, school etc. and store this clustered location together with an identifier. Subsequently, a user of the Privacy Module may be prompted to automatically, or via user input, establish an offset location to associate with this identifier.

Accordingly, in a similar manner to that described above of another user running repeated searches to increase their prediction of the user's accurate location a user may be anticipated to start each morning at home Monday-Friday. Hence repeatedly offsetting the user's location by 1-2 km, for example, each day, week, engagement of Privacy Module etc. may again provide over a period of time sufficient data for analysis to remove the offset, entirely or in part. However, now an identifier associated with a location is stored and maintained so that a constant offset location, approximate location, is employed for this cluster of locations. Further, additional locations may subsequently be associated with a cluster and hence the consistent offset location is applied. In this manner, motions of the user may now be mapped to this offset location. Subsequently, a user with cluster associated locations, e.g. “home” and “work” may exploit one or more third party applications/Internet portals to automatically establish a journey between these end points. For example, a user in New York may establish “home” as within Carnesie, within the New York City borough of Brooklyn, and “work” as within the West Village district of Manhattan, New York City with the user walking to the Carnesie-Rockaway Parkway station for the L-train, taking the L-train to 14^{th} Street subway station and then walking about 7 blocks to the New York University campus. Accordingly, this daily commute may be amended to reflect information provided by the Manhattan Transport Authority.

Within embodiments of the invention supra in respect of FIGS. 7A through 21 the region within which an approximate or offset location is established has been discussed with respect to a series of radii centred upon the user's current location. Accordingly, a region for establishing an approximate location may be between a first radius and a second radius, these being established by the range of offset the user desires to apply, for example. However, it would be evident that other boundaries may be employed, e.g. square, as well as other regular and irregular shapes including but not limited to triangles, rectangles, pentagons, and hexagons.

Within the embodiments of the invention the establishment of the location of a user's PED has been primarily described with respect to Global Positioning System as operated by the U.S. Department of Defense. However, it would be evident that other location based systems employing satellite based navigation systems may be employed including, for example, the Russian Global Navigation Satellite System (GLONASS), European Union Galileo, Chinese Compass, and the Indian Regional Navigational Satellite System. However, other approaches including, but not limited to, triangulation, base station association, etc. may be employed without departing from the scope of the invention.

It would be evident to one skilled in the art that beneficially Privacy Modules such as those described supra in respect of embodiments of the invention provide for the user of PED to present one or more levels of approximation/offset to their true physical location to users of SOCNETAPs and other applications without the user losing the benefit of maintaining a true GPS or other location determination based position such that they are able to exploit location based services relevant to their true location, e.g. public transport options, public transport timetables, restaurant options, mapping and directions etc., whilst providing varying degrees of approximation/offset to immediate family, family, friends, acquaintances, and others accordingly to their personal preferences. Such services, for example, are generally “pull” in that a user enters and/or provides information based upon which the information is retrieved and presented without an automatic association that the information relates to their current real physical location. For example, a user may search Amtrak to find schedules and fares for trains, such as from New York—Penn Station to Boston—South Station but may be in San Francisco, Seattle, or Tokyo when doing so.

However, in other instances the services are “push-pull” in that location information is provided to the user based upon their location information being “pushed” to the service and then the information “pulled” by the user's PED/FED. In these instances if the user wishes to access location based services without disclosing their true location then as discussed supra Privacy Modules according to embodiments of the invention provide for a partitioning of location information provided to some services and/or service providers from that provided to users of SOCNETAPs and/or SSSAs such that the user can apply varying degrees of approximation/offset to immediate family, family, friends, acquaintances, and others accordingly to their personal preferences. Accordingly, location information is partitioned allowing the user to access content associated with their real physical location, e.g. by exploiting GPS based applications such as “Sygic”, “Where”, “NearBy Food”, “Restaurant Finder”, “MapMyRun”, and “CityGuide” for example, hereinafter referred to as “LocationApps” whilst allowing them to offset their true location to contacts they do not wish to have their true location.

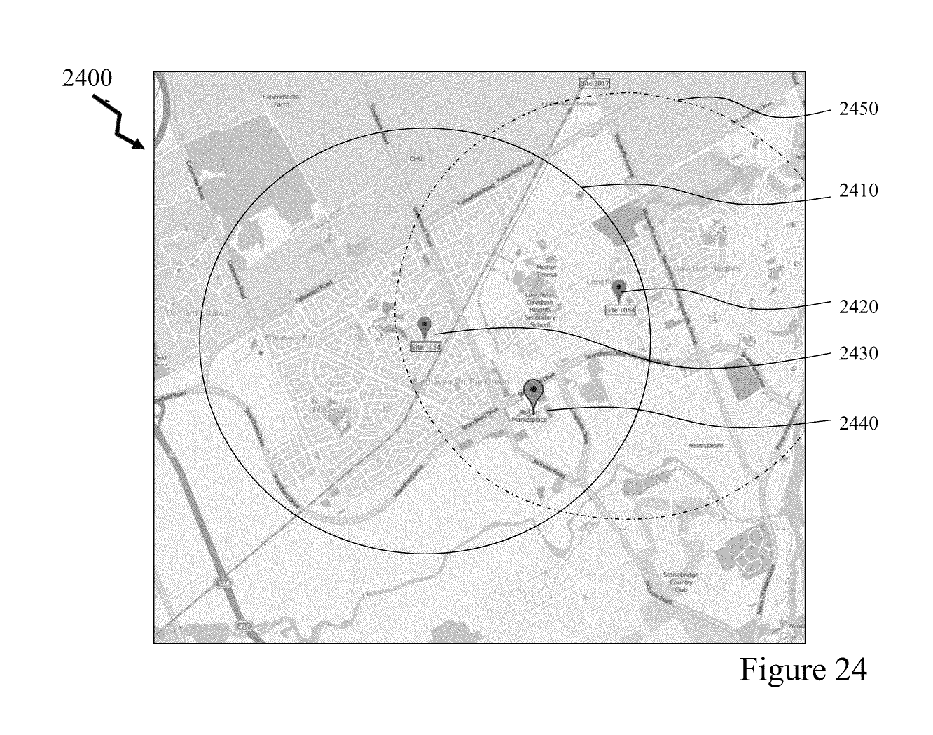

However, it would be evident that the user may still wish to restrict such location information as they may wish to provide any real GPS location to a third party service they do not wish to have it. Accordingly, the user may exploit an additional embodiment of the invention wherein a Privacy Module according to an embodiment of the invention may interface with a “Location-Proxy” which provides information information to the user's PED for use in requesting information and/or accessing the Internet with a modified location. For example, the Location-Proxy is Cell Mapper (www.cellmapper.net) which allows the user's PED to establish that, the user as a Bell™ customer using 3G-UMTS services, and they are currently at the RioCan Marketplace 2440, as seen in schematic 2400 depicted in FIG. 24 in Barrhaven-on-the-Green, Ontario, Canada receiving information from the current cell tower the user's device is accessing, e.g. that based at site 1154 being first tower 2430. Also depicted is second tower 2420 at site 1054 which the user's PED may alternatively access. The Location-Proxy establishes a first zone 2410 at a predetermined radius from first tower 2430 within which the user's PED would also be able to communicate with the first tower 2430. Accordingly, any location within the first zone 2410 would receive the same messaging relating to special offers from businesses within the RioCan Marketplace 2440 which exploit 3G—UMTS communications to deliver the special offers. Accordingly, the Privacy Module may establish a position within the first zone 2410 other than the real user's location for communications thereby receiving locally targetted messaging, advertisements etc. but without providing any service including Bell™ itself the true user location. Hence, the user may establish multiple offset locations as described above in respect of embodiments of the invention as well as offsetting their position to location based services they wish to access within the vicinity of their true location. If the user's PED were associated with the second tower 2420 then the user's position may be established within a second zone 2450 around the second tower 2420.

Within the description above in respect of embodiments of the invention the establishment of geo-location information relating to the user has been primarily described from the viewpoint of exploiting Global Positioning System (GPS) circuits within portable electronic devices to acquire the geo-location information which is then processed locally or remotely to provide approximate location information rather than the prior art “ON” (accurate) and “OFF” (hidden) options. However, it would be evident to one skilled in the art that user geo-location information may be acquired through other means including, but not limited to, association of the device with particular network elements, triangulation of the device from multiple network elements, or association of the device with another device via a short range communications link, e.g. Bluetooth, where the other device is transmitting geo-location information.

Within the embodiments of the invention described supra the Privacy Module provides the user with the ability to establish an “offset” in their location relative to the their real location where the “offset” may be set through a range of processes with or without user determination of the exact “offset” location other than establishing a range. The Privacy Module as described may form part of a SOCNETAP or other software application in execution upon the user's PED. However, the Privacy Module may also form part of the PED's operating system interfacing to all SOCNETAPs and other applications on the user's PED or it may itself be a separate application in execution upon the user's PED or accessed by the user's PED through a network, e.g. the Internet. Whilst embodiments of the invention in respect of FIGS. 1 through 14 have been presented and described with respect to social media it would be evident to one skilled in the art that the applications accessing the “offset” and/or approximate location may be any application exploiting and/or utilizing location based data, be it GPS or otherwise derived. Accordingly, the Privacy Module may be associated with one or more applications and/or features of the user's PED whilst if accessed by emergency services the PED maintains its correct location as it modifies metadata and other data as appropriate to other applications and/or services but does not introduce any modification to the internal reference location data of the PED.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
receiving from a user upon an electronic device associated with the user an indication of a degree of privacy;
receiving upon the electronic device first location information relating to the location of the electronic device; and
modifying the first location information in dependence upon at least the indication of the degree of privacy.

2. The method according to claim 1 wherein;
the indication of a degree of privacy is at least one of:
a measure of distance to be introduced into the location information to hide the true location of the user;
a measure of angle as specified by an international standard of measuring position on the surface of the Earth; and
the indication of a degree of privacy is a value established in dependence upon a user selection upon the electronic device.

3. The method according to claim 1 wherein,
the received indication of a degree of privacy determines the modification to the location information, the location information being modified by at least one of a rounding of, a truncation of, an offset applied to, a pseudorandom offset applied to, and a predetermined offset applied to the location information.

4. The method according to claim 1 further comprising;
receiving second location information relating to a subsequent location of the electronic device;
modifying the second location information in dependence upon at least the indication of the degree of privacy and a factor established in dependence upon at least the degree of privacy wherein,
the factor is at least one of a scaling factor to be applied to the distance between the second location information and first information and a direction adjustment to be applied to the vector between the second location information and first information.

5. The method according to claim 4 wherein,
the modified second location information in conjunction with the modified first location information if presented to another user indicates different least one of speed and direction of movement.

6. A method comprising:
storing within a memory of an electronic device associated with the user an indication of a degree of privacy;
receiving upon the electronic device electronic content including location information relating to the electronic content; and
modifying the location information within the electronic content in dependence upon at least the indication of the degree of privacy.

7. The method according to claim 6 wherein;
the indication of a degree of privacy is at least one of:
a measure of distance to be introduced into the location information to hide the true location of the user; and
the indication of a degree of privacy is a measure of angle as specified by an international standard of measuring position on the surface of the Earth; and
a value established in dependence upon a user selection upon the electronic device.

8. The method according to claim 7 wherein,
the received indication of a degree of privacy determines the modification to the location information, the location information being modified by at least one of a rounding of, a truncation of, an offset applied to, a pseudorandom offset applied to, and a predetermined offset applied to the location information.

9. A method comprising:
receiving from a user upon an electronic device associated with the user digital content including location information data relating to the true location of the electronic device and degree of privacy information data as determined by the user relating to an offset distance from the said true location information in order to hide the said true location; and
modifying the location information within the digital content in dependence upon at least the indication of the degree of privacy.

10. The method according to claim 9 wherein;
the degree of privacy information data relates to at least one of:
a measure of distance to be introduced into the location information to hide the true location of the user;
a measure of angle as specified by an international standard of measuring position on the surface of the Earth; and
a value established in dependence upon a user selection upon the electronic device.

11. The method according to claim 9 wherein,
the received degree of privacy information data determines the modification to the location information data, the location information data being modified by at least one of replacing the location information data with location information data of another location and applying a process to the location information data, the process selected from the group comprising rounding to a predetermined accuracy, truncating to a predetermined accuracy, adding a predetermined offset, and adding a pseudorandomly determined offset, the selected process being applied to the location information.

12. The method according to claim 9 further comprising;
modifying the digital content in dependence upon at least the indication of the degree of privacy comprises at least one of:
setting the location information data to that associated with a location selected by the user within a region defined by first and second boundaries;
setting the location information data to that associated with a predetermined portion of a predetermined region of the landscape surrounding the user's current location wherein the landscape is defined by at least a first boundary; and
replacing the location information data with geo-tag data of another item of digital content selected by the user.

13. The method according to claim 9 wherein,
modifying the digital content in dependence upon at least the indication of the degree of privacy comprises setting the location information data to a predetermined location of a plurality of predetermined locations, each predetermined location being established by associating a location to a cluster of real locations wherein the location is offset from the cluster of real locations by a predetermined factor determined in dependence upon the indicated degree of privacy.

14. A method comprising:
receiving at a server from an electronic device associated with a user first digital content, the first digital content having associated with it metadata including location information data relating to the true location of the electronic device when the first digital content was acquired;
receiving at the server second digital content, the second digital content having associated with it metadata including location information data relating to a pre-selected error in the true location established by the user;
receiving at the server a request from a third party to view posted digital content relating to the user, the request including at least data relating to an identity of the third party; and
providing to the third party content as the posted digital content comprising one of the first digital content and the second digital content, the one of being determined in dependence upon at least the data relating to an identity of the third party.

15. The method according to claim 14 wherein,
at least one of:
the location information data relating to said pre-selected error in the true location established by the user is established in dependence upon at least a degree of privacy information data established by the user;
the first and second digital content comprise the same content but differ in the data relating to the location information data wherein the difference in location information data is established by degree of privacy information data; and
the first and second digital content comprise different content and differ in the data relating to the location information data wherein the difference in location information data is established by degree of privacy information data.

16. The method according to claim 15 wherein,
the received degree of privacy information data determines the modification to the location information data to generate the location information data relating to another location, the modification made by applying a predetermined process to the location information data.

17. The method according to claim 16 wherein,
the process is selected from the group comprising rounding the location information to a predetermined accuracy, truncating the location information to a predetermined accuracy, adding a predetermined offset to the location information, adding a pseudorandomly determined offset to the location information, having the user select a location within first and second boundaries centred on the location information data, and setting the location information data to that associated with a predetermined portion of a predetermined region of the landscape surrounding the user's current location wherein the landscape is defined by first and second boundaries centred on the location information data.

18. The method according to claim 14 wherein,
the second digital content having associated with it metadata relating to another location said pre-selected error in the true location was selected by the user, the second digital content selected being one of a plurality of second digital content provided to the user in dependence upon at least degree of privacy information data established by the user.

19. A method comprising:
receiving from a user upon an electronic device associated with the user an indication of a degree of privacy;
acquiring with the electronic device digital content, the digital content including location information data relating to the location of the electronic device; and
modifying the digital content in dependence upon at least the indication of the degree of privacy.
